(19) United States
(12) Patent Application Publication
(10) Pub. No.: US 2009/0305132 A1
(43) Pub. Date: Dec. 10, 2009

(54) Electrode material including a complex lithium/transition metal oxide

(75) Inventors: Michel Gauthier, La Prairie (CA); Christophe Michot, Montreal (CA)

Correspondence Address: BUCHANAN, INGERSOLL & ROONEY PC, POST OFFICE BOX 1404, ALEXANDRIA, VA, 22313-1404, US

(73) Assignee: PHOSTECH LITHIUM INC., Saint-Bruno, QC (CA)

(21) Appl. No.: 11/919,925

(22) PCT Filed: May 5, 2006
(86) PCT No.: PCT/FR2006/001019

§ 371 Date: Nov. 6, 2007

(30) Foreign Application Priority Data
May 6, 2005 (CA) 2,506,104

(51) Int. Cl. H01M 4/48; H01M 4/60; H01M 4/62; H01M 10/26; B05D 5/12; H01B 1/24

(52) U.S. Cl. 429/207; 429/231.1; 429/221; 429/224; 429/231.2; 429/223; 429/231.3; 429/220; 429/231; 429/212; 429/217; 427/115; 252/506; 977/742; 977/890

(57) ABSTRACT

The invention relates to an electrode material and a composite electrode including same. The electrode material consists of particles or particulate aggregates of a complex LiᵢMₘM′_{m′}Z_{z}OₒNₙF_{f} oxide, wherein M is at least one transition metal, M′ is at least one metal other than a transition metal, Z is at least one non-metal, coefficients i, m, m′, z, o, n and f are selected in such a way that the complex oxide is electrically neutral, with i=0, m>0, z=0, m′=0, o>0, n=0 and f=0. At least part of the complex oxide particle or particulate aggregate surface is coated with a carbon layer bound by chemical bonds and/or physical bonds to the carbon. The complex oxide has formula; the carbon has covalently bonded functional groups GF.

The present invention relates to redox compounds in the form of particles with a surface-modified carbon coating, and to their use as electrode material.

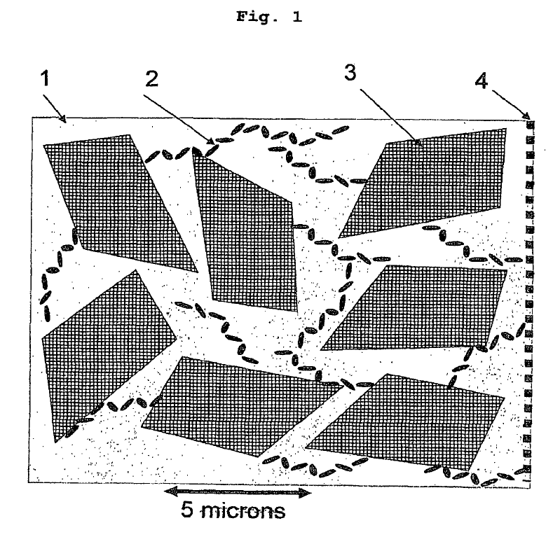

In the field of lithium-ion batteries or lithium-metal/polymer batteries, it is known practice to use oxides as active cathode material. Mixed lithium/transition metal oxides such as LiMn₂O₄, LiCoO₂, LiNi_{1/3}Co_{1/3}Mn_{1/3}O₂, Li₍₁₊ₓ₎V₃O₈ or LiNiO₂ are commonly used in lithium batteries that are marketed, or in prototype batteries. The structure of these composite electrodes is represented schematically in FIG. 1. (1) denotes the binding, (2) denotes the carbon particles (agent conferring electron conductivity), (3) denotes the oxide particles and (4) denotes the current collector.

The use of LiFePO₄ is currently the subject of numerous studies, in particular for safety and cost reasons (See U.S. Pat. No. 5,910,382, U.S. Pat. No. 6,514,640, U.S. Pat. No. 6,477,951 and U.S. Pat. No. 6,153,333). LiFePO₄ constitutes a significant example of complex oxides LiMXO₄ in which M represents a metal and X a non-metal such as P, S or Si. It is understood that this formula encompasses complex oxides in which M represents one or more transition metals, and is optionally replaced in part with a metal other than a transition metal, X represents one or more elements of the “non-metal” type, and the anion XO₄ is partially replaced with one or more other oxyanions of formula XO₄, and also complex oxides whose atomic composition varies slightly around the stochiometry. It has been demonstrated (U.S. Pat. No. 5,910,382) that such complex oxides, in which the phosphate polyanion or the sulfate polyanion has a certain crystalline structure (olivine or nasicon, for example), have a high redox tension with respect to low-cost transition metals such as Fe or Ti, which makes them chemically stable and attractive as an alternative to LiCoO₂ for the development of cathodes. However, most of these complex oxides are electrical insulators and they have a low intrinsic electron conductivity.

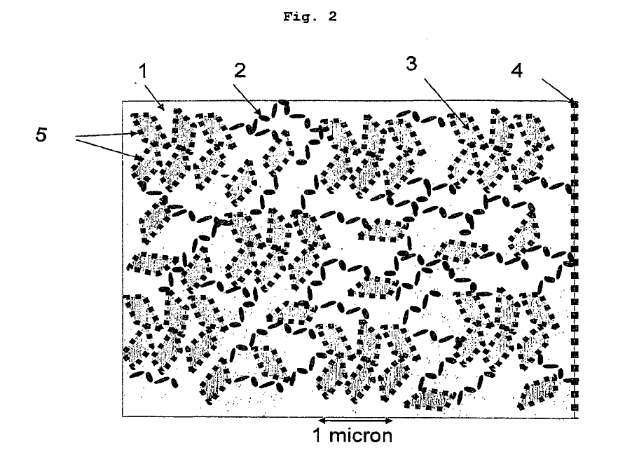

This drawback can be overcome by applying to the particles of complex oxide a more or less continuous carbonaceous deposit or layer which is bonded to the surface of the particles of complex oxide, but without excluding the presence of carbon in the complex oxide grains or in the particle agglomerates, said carbonaceous layer being obtained, for example, by pyrolysis of a precursor during the synthesis of the complex oxide or after the synthesis of the complex oxide (U.S. Pat. No. 6,855,273, U.S. Pat. No. 6,962,666, WO-0227824 and WO-0227823), or by mechanofusion in the presence of particles of carbon powder (cf. U.S. Pat. No. 5,789,114 and WO 04/008560). The use of this carbonaceous material in the form of a composite electrode is represented schematically in FIG. 2. (1) denotes the binder, (2) denotes the carbon particles (agent generally used to confer electron conductivity in the composite electrode), (3) denotes the particles of complex oxide, (4) denotes the current collector and (5) denotes the particles of carbon bonded to the surface of the particles of complex oxide.

However, LiFePO₄, whether uncoated or coated with a carbonaceous layer, is used in the form of very small particles in order to increase the power characteristics and to compensate for the low diffusivity of lithium ions. The specific surface area as determined by BET is consequently very high. It is generally of the order of 14 m²/g [more generally of 5-20 m²/g for LiFePO₄ coated with a carbon layer and denoted LiFePO₄—C]. Because of this high specific surface area, the amount of binder necessary to ensure the cohesion of the complex oxide particles within a composite electrode is greater than that which is required to ensure the cohesion of LiCoO₂ particles which are larger. In addition, due to the presence of the carbon, the particles are more hydrophobic and therefore more difficult to process for the development of a composite electrode.

Several approaches exist for the development of composite electrodes for lithium batteries. In lithium-ion battery technology, a cathode can be prepared by a process consisting in dispersing a cathode material, carbon particles as an agent for improving conductivity and a binder, in a solvent, and applying it to a current collector by coating. The porous cathode thus obtained is then impregnated with a liquid electrolyte, including an electrolyte based on ionic liquids. Alternatively, the porous cathode can be obtained by extrusion of a mixture comprising a cathode material, carbon particles and a binder. In lithium-metal/polymer battery technology, a cathode can be obtained by a process consisting in preparing a mixture comprising a cathode material, carbon particles and an ion-conductive polymer [for example, a solvating poly(ethylene oxide) derivative mixed with a lithium salt such as LiN(SO₂CF₃)₂, and then applying the mixture to a current collector, either by coating using a solution in a solvent, or by extrusion. The cathode can also be obtained by preparing a porous cathode by applying to a collector by coating or by extrusion, a composition comprising the cathode material, carbon particles and a binder, and then by impregnating the porous cathode thus obtained with an ion-conductive polymer in liquid form, and crosslinking the polymer in situ.

The use of aqueous compositions is widely known for the production of anodes, but more recently for the production of cathodes. The implementation of such aqueous-route processes makes it possible in particular to avoid the use of N-methylpyrrolidone as a coating solvent (See for example U.S. Pat. No. 5,721,069, U.S. Pat. No. 6,399,246, U.S. Pat. No. 6,096,101, WO-04/045007 and JP-2003-157852). Aqueous binders are commercially available. Mention may in particular be made of the product LHB-108P from the company LICO Technology Corp. (Taiwan, product available from the company Pred Materials, United States) in the form of an aqueous suspension of a modified styrene-butadiene copolymer, or the product BM-400B from the company Zeon Corporation, (Japan), in the form of an aqueous dispersion of elastomer particles.

The complete or partial replacement of a mixture of complex oxide and of carbon powder with particles of carbonaceous complex oxide, for the production of a composite cathode, makes it possible to limit the total amount of carbonaceous material and, consequently, to increase the proportion of active material. However, the development of batteries comprising a cathode obtained by deposition of a carbonaceous complex oxide is limited by many drawbacks, due to the fact that the carbon coating applied to the particles of complex oxide confers hydrophobic properties on the latter and modifies the surface tension, thereby leading to degradation of the ion and electron exchanges with the other constituents of the composite cathode, and modifies the physical properties of the complex oxide, and in particular its wettability, its adhesion to the binder and its extrusion capacity.

The inventors have found that it is possible to overcome these drawbacks while at the same time maintaining the advantages of the complex oxide particles simply coated with carbon. The solution proposed consists in modifying the surface of the carbon by bonding functional groups by covalent bonding or ionic bonding, so as to improve the working properties of the carbonaceous complex oxides by taking advantage of the many possibilities offered by the functional groups grafted to the surface of the carbon. The complex oxides thus modified, firstly, provide new types of compositions of materials for composite electrodes, by taking advantage of the great diversity of the functional groups that may be used. Secondly, they can improve the processes for producing electrodes.

Therefore, the present invention provides a new electrode material, a process for preparing it, and a composite electrode comprising said material and a generator comprising said electrode.

An electrode material according to the present invention consists of particles or particulate aggregates of a complex oxide which has redox properties and which can reversibly insert the lithium cation, in which at least part of the surface of the complex oxide particles or particulate aggregates is coated with a carbon layer bonded by chemical bonds and/or physical bonds and, optionally, by mechanical attachment, and is characterized in that:
a) the complex oxide corresponds to the formula

LiᵢMₘM′_{m′}Z_{z}OₒNₙF_{f} (I)

in which:
Li, O, N and F represent, respectively, lithium, oxygen, nitrogen and fluorine;
M represents one or more elements chosen from transition metals;
M′ represents one or more metals other than a transition metal;
Z represents at least one non-metal;
the coefficients i, m, m′, z, o, n and f are chosen so as to ensure electroneutrality of the complex oxide, and meet the following conditions:
i≧0, m>0, z≧0, m′≧0, o>0, n≧0 and f≧0;
b) the carbon carries covalently bonded functional groups GF;
c) the size of the particles and particulate aggregates of carbonaceous complex oxide is such that at least 90% of the particles are between 1 nm and 5 μm in size, and if the particles are present in the form of aggregates, at least 90% of the particulate aggregates are between 10 nm and 10 μm in size.

A carbonaceous complex oxide as defined above will subsequently be referred to as “material I”.

In a specific embodiment, the size of the particles and of the particulate aggregates is such that at least 90% of the particles are between 10 nm and 1 μm in size, and if the particles are present in the form of aggregates, at least 90% of the particulate aggregates are between 100 nm and 10 μm in size.

Preferably, M represents one or more transition metals M1 chosen from iron, manganese, vanadium and titanium. In a specific embodiment, the metal(s) M1 is (are) partially replaced with one or more transition metals M2 preferably chosen from molybdenum, nickel, chromium, cobalt, zirconium, tantalum, copper, silver, niobium, scandium, zinc and tungsten, it being understood that the weight ratio of the metals M1 to the metals M2 is greater than 1. The transition metals M2 are chosen either for their redox properties complementary to those of the transition metals M1, or for their influence on the electron or ion conductivity properties of the complex oxide.

A metal M′ other than a transition metal is preferably chosen from Li, Al, Ca, Mg, Pb, Ba, In, Be, Sr, La, Sn and Bi. Because M′ is inert from the redox point of view, its content m′ is preferably less than 10% by weight of the complex oxide. A metal M′ is chosen for its influence in particular on the electron conduction or on the diffusivity of the lithium ions in the partially substituted complex oxide structure.

The non-metal element Z is preferably chosen from S, Se, P, As, Si and Ge.

A family (II) of materials (I) according to the invention comprises the materials which contain a complex oxide corresponding to general formula (I) above in which i>0. The presence of Li in the composition of the complex oxide of formula (I) makes it possible to stabilize certain structures of compounds which are produced during the synthesis of the material (II), and in particular during carbonization if carbonization is used for the depositing of the carbon onto the complex oxide. The materials (II) are particularly useful for the implementation of electrochemical generators prepared in the discharged or partially discharged state.

A family (III) of materials (I) according to the invention comprises the materials which contain a complex oxide in which z=0, and which corresponds to formula (III) LiᵢMₘM′_{m′}OₒNₙF_{f}. The materials of family (III) generally have relatively low electrode potentials with respect to a lithium anode, in particular when the transition metal M1 is iron or titanium. As a result, a material (III) is particularly useful for the production of the anode of a rechargeable lithium generator.

A specific case (IIIa) of materials (III) consists of a material in which M represents titanium. Mention may in particular be made of materials which contain a titanate of formula LiᵢTiₘM′_{m′}OₒNₙF_{f}, more particularly the titanate of approximate formula Li₄Ti₅O₁₂. An anode consisting of a material of family (IIIa) has notable cycloability properties when the particles of carbon-coated titanate are from 1 to 10 nm, for example, in size. In addition, when the carbon is deposited by carbonization during the synthesis of the material (IIIa), said carbon contributes to the controlling of the sizes of the elemental particles by preventing sintering of the complex oxide.

A family (IV) of materials (I) according to the invention comprises the materials which contain a complex oxide in which z≠0. The presence of a non-metal covalently bonded to the oxygen of the complex oxide substantially contributes to the increased voltage of the redox couple of the transition metal with respect to a lithium anode, but it renders the complex oxide electrically insulating. However, this low electrical conductivity is very markedly compensated for by the presence of the carbon coating at the surface of the complex oxide. The use of an oxide containing a non-metal consequently makes it possible to considerably broaden the choice of electrode materials, in particular cathode materials, available for the rechargeable lithium generators.

Among the materials (IV), mention may in particular be made of the materials which contain a complex oxide of general formula LiMM′ZO₄ of olivine structure, and the materials of general formula Li₃₊ₓ(MM′)₂(ZO₄)₃ of Nasicon structure. It is understood that the two general formulae above encompass all the complex oxides having differences in stochiometry of less than 5%, a content of chemical impurities of less than 2% and a content of elements of substitution of the crystalline sites M of less than 20%, and the complex oxides in which the polyanions ZO₄ are partially replaced with molybdenate, niobate, tungstate, zirconate or tantalite polyanions to a degree of less than 5%. Said formulae also encompass the complex oxides in which Z represents phosphorus and part of the oxygen of the phosphate structures is replaced with nitrogen or fluorine (i.e. n>0 and/or f>0).

A specific case (IVa) of materials (IV) consists of a material in which Z represents phosphorus. A material (IVa) contains a phosphate, a pyrophosphate or an oxyphosphate. As a specific example, mention may be made of the materials (IVa) which contain LiFe₁₋ₓMgₓPO₄ in which x ranges between 0.1 at % and 5 at %, and in particular LiFePO₄. A material (IVa) can be produced in particular with iron and manganese, which are abundant and inexpensive materials. The use of a material (IVa) as complex electrode materials nevertheless allows a high functioning voltage. The materials (IVa) are therefore particularly advantageous as substitutes for the cobalt-based, nickel-based or manganese-based oxides currently used in rechargeable lithium-ion storage batteries. The materials (IVa), in particular when they contain iron and manganese, are consequently interesting materials for the new generations of storage batteries for hybrid vehicles, electric vehicles, portable tools and stationary reserve storage batteries.

Another specific case (IVb) of materials (IV) consist of the materials which contain a complex oxide of formula (I) in which Z represents Si or S. Mention may in particular be made of the materials (IVb) in which the complex oxide is a silicate, a sulfate or an oxysulfate in which M1 is Fe or Mg or a mixture thereof. The materials (IVb) have substantially the same properties and the same advantages as the materials (IVa).

Among the materials of group IV, those for which the complex oxide has an olivine or a Nasicon crystalline structure and which contain Fe or Mn as major metal M1 and an oxyanion of ZO₄ type (i.e. o=4, n=f=0), are most particularly preferred. Said crystalline structures have excellent reversible insertion/deinsertion properties and, in addition, they contribute, with the ZO₄ oxyanions, to the obtaining of high electrode potentials with respect to a lithium anode. These materials are consequently particularly advantageous for the production of cathodes.

In an electrode material (I) according to the present invention, a functional group GF covalently bonded to the carbon which coats the complex oxide meets at least one of the following criteria:
it is hydrophilic in nature;
it constitutes a polymeric segment;
it has redox properties and/or electron conductivity;
it carries or constitutes a functional group FR capable of reacting by substitution, addition, condensation or polymerization, or a functional group capable of initiating anionic, cationic or radical polymerization reactions.

A more detailed description of the functional groups GF is given hereinafter. Certain functional groups having several properties can therefore be mentioned in several categories.

A GF group that is hydrophilic in nature can be chosen from ionic groups and groups consisting of a hydrophilic polymer segment. The presence of GF groups that are hydrophilic in nature improves the hydrophilic nature of the material itself, thereby resulting in an improvement of the wettability of the material, which subsequently allows better impregnation of the material by liquid (in particular by a liquid electrolyte, an ionic liquid or a liquid solvating polymer of low mass); the possibility of making depositions using aqueous compositions; the possibility of obtaining materials that are readily dispersed in an aqueous medium or in polar polymers; and an improvement in surface tension, which favors the extrudability of the material.

A GF group that is hydrophilic in nature, of the ionic group type, can be chosen in particular from the groups CO₂M, —OH, —SM, —SO₃M, —PO₃M₂, —PO₂M and NH₂, in which M represents a proton, an alkali metal cation or an organic cation. An ionic GF group that is hydrophilic in nature can be bonded to the carbon either directly or by means of a polymer group. The organic cation can be chosen from oxonium, ammonium, quaternary ammonium, amidinium, guanidinium, pyridinium, morpholinium, pyrrolidionium, imidazolium, imidazolinium, triazolium, sulfonium, phosphonium, iodonium and carbonium groups, said groups optionally carrying at least one substituent having a functional group FR capable of reacting by substitution, addition, condensation or polymerization, as defined above.

When a GF group is intended to improve the wettability and/or the dispersibility of the electrode material, M is preferably H or an alkali metal. In this embodiment, the surface tension of the material is increased. In addition, when M is an alkali metal, the ionic groups play a buffering role with respect to the acid species that may be present in an electrochemical generator which contains an electrode material according to the invention. For example, in a generator in which the electrolyte is LiPF₆-based, HF may be present because it was initially introduced into the electrolyte or because it forms while the generator is operating. The reaction of HF with, for example, —CO₂Li or —SO₃Li groups results in the formation of insoluble LiF and of the anion grafted in acid form —CO₂H or —SO₃H, thus limiting the possibilities of generator performance degradation. In a preferred embodiment of the invention, M is Li.

A GF group that is hydrophilic in nature may be a group derived from a hydrophilic polymer. The GF group may, for example, be a group derived from a polyalkylene comprising heteroatoms such as oxygen, sulfur or nitrogen, in particular a group derived from poly(oxyethylene), from poly(ethyleneimine) or from polyvinyl alcohol, or a group derived from an ionomer having, in its macromolecular chain, acrylate groups, styrene carboxylate groups, styrene sulfonate groups, allylamine groups or allyl alcohol groups. In one embodiment, a hydrophilic polymer GF group also carries an functional group FR capable of reacting by substitution, addition, condensation or polymerization, as defined hereinafter.

A GF group may be a group comprising at least one polymeric segment optionally carrying one or more FR functions enabling either subsequent crosslinking or bonding with another molecule.

A polymeric GF group may comprise one or more segments corresponding to the following definitions:
a poly(oxyethylene) segment which can act as a binder and of an electrolyte;
a segment which has elastomer properties which can act as a mechanical binder;
a segment which has conjugated double bonds capable of ensuring electron conduction.

The FR functions are as defined hereinafter.

When an electrode material (I) according to the invention carries a GF group which is or which carries an FR functional group capable of reacting by addition, condensation or polymerization, the FR groups present on the surface of the carbonaceous coating of the complex oxide particles of the material (I) make it possible to bond the particles to one another if the FR groups are capable of reacting with one another. The FR groups also make it possible to bond the carbonaceous complex oxide particles of the material (I) to other constituents of the composite electrode if said constituents carry FR′ groups capable of reacting with the FR groups by addition, condensation or polymerization. This embodiment is advantageous insofar as it makes it possible to readily apply the complex electrode material to a collector by coating or extrusion, and then to confer mechanical strength on the whole assembly by reaction of the FR and FR′ groups. Finally, the FR groups make it possible to produce a material (I) that is modified by reaction with a compound which has an FR′ group. The determination of the FR functions and of the FR,FR′ couples is within the scope of those skilled in the art, who can find the useful information in basic chemistry manuals. Some examples, which are no way limiting in nature, are given in the following table.

FR

| FR′ | >C═C< | —COOH | —OH | —NH₂ |
|---|---|---|---|---|
| >C═C< | —C—C— | | | |
| isocyanate | | amide | ester | amide |
| epoxide | | ester | ether | imine |
| aziridine | | ester | ether | imine |
| thiaaziridine | | ester | ether | imine |
| amine | | amide | | |
| oxazoline | | ester | | |
| —OH | | ester | | |
| Cl | | | ether | |
| Activated | | | | imine |
| double bond | | | | |

The physical characteristics of the carbon coating depend essentially on the method of application of the coating.

A non-powdery carbon coating that adheres to the surface of the complex oxide particles is obtained when the carbon is applied by carbonization of a precursor brought into contact beforehand with the complex oxide particles, or when the carbon deposition and the synthesis of the complex oxide are carried out simultaneously.

The deposition of a carbon coating by carbonization of a precursor is described in particular in U.S. Pat. No. 6,855,273 and in U.S. Pat. No. 962,666. The complex oxide particles or particulate aggregates are brought into contact with an organic carbon precursor, and the mixture is then subjected to a treatment aimed at carbonizing the precursor. The precursor is preferably in liquid or gas form, for example in the form of a liquid precursor, of a gas precursor or of a solid precursor used in the molten state or in solution in a liquid solvent. The carbonization may be dismutation of CO, dehydrogenation of a hydrocarbon, dehalogenation or dehydrohalogenation of a halogenated hydrocarbon, or gas-phase carbonization of hydrocarbons preferably rich in carbon. Such a process gives a carbon deposit which has a good covering capacity and adheres well to the complex oxide particles. A carbonization carried out by cracking of a hydrocarbon such as acetylene, butane, 1,3-butadiene or propane, as described in particular in US 2004/0157126, is favorable to the production of carbon nanotubes in the carbon coating.

In a variant of the carbonization process, the precursor is mixed, prior to the carbonization, with carbon particles or fibers, including carbon nanotubes, optionally containing GF groups, in particular sulfonates or carboxylates, making it possible to obtain a composite coating.

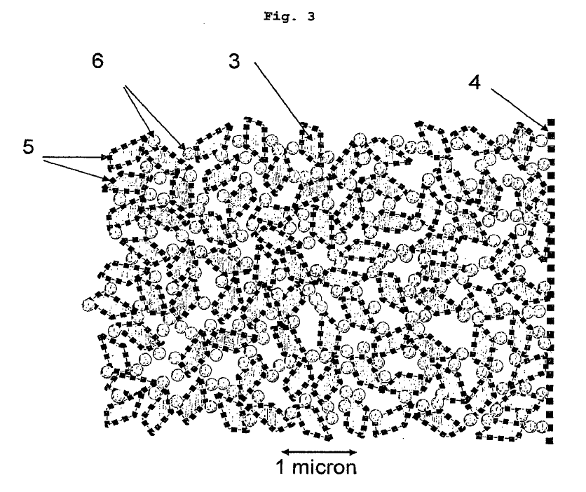

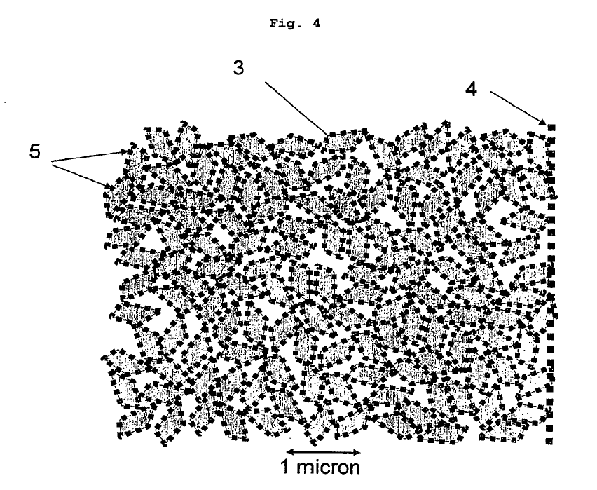

When the oxide is at least slightly porous, the organic precursor can penetrate into the particles to a certain depth, thereby guaranteeing good mechanical anchoring before or during the carbonization. Partial or complete covering of the surface by the precursor can be observed from the residual carbon after carbonization, as illustrated in FIGS. 3 and 4. FIGS. 3 and 4 each represent a TEM micrograph obtained using a GIG spectrometer from the company Gatan for a carbonaceous LiFePO₄. In addition to the mechanical anchoring resulting from a carbon coating which closely follows the surface profile of the complex oxide particles or which penetrates into the core of the complex oxide particles, the chemical or physical interactions developed during the carbonization between the surface of the complex oxide and the carbon reinforce the attachment of the carbon coating.

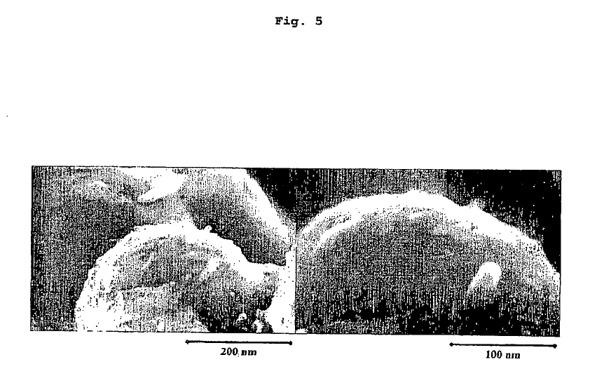

In a specific embodiment, the carbon coating comprises carbon nanotubes. This embodiment promotes the anchoring of a polymer with the carbonaceous coating of the complex oxide. The nanotube structure of a carbonaceous coating is described in greater detail by Henry J. Liu et al. [Applied Physic Letters, vol. 85, 5, pp 807-809, 2004], and S. H. Jo et al., [Applied Physic Letters, vol. 85, 5, pp 810-812, 2004]. The presence of nanotubes is visible on the micrograph in FIG. 5. The synthesis of nanotubes at the surface of the material can be carried out simultaneously with the carbonization or after the carbonization. A carbon coating which comprises carbon nanotubes can be obtained by the carbonization or the cracking of gaseous hydrocarbons in the presence of the complex oxide, preferably in the presence of iron, cobalt or nickel under conditions known to those skilled in the art (cf. Lee C. J., Kim D. W., Lee T. J., et al., Applied Physics Letters, vol. 75, 12, pp. 1721-1723, 1999], [Yuan Chen, Dragos Ciuparu, Yanhui Yang, Sangyun Lim, Chuan Wang, Gary L. Haller and Lisa D. Pfefferle, Nanotechnology, vol. 16, 2005, p 476-483], and [Mark Meier, Energeia, vol. 12, No. 6, 2001, publication of the University of Kentucky]).

In another embodiment, the carbon coating in intimate contact with the surface of the complex oxide particles is obtained by mechanofusion. A coating deposited by mechanofusion is powdery in nature, which is not observed on a carbon coating deposited by carbonization of an organic precursor. The adhesion of the carbon deposited by mechanofusion, with the surface of the complex oxide, is obtained by mechanical bonding of the carbon with the surface of the complex oxide. The mechanical bonding probably takes place, inter alia, by means of physical bonds or chemical bonds which result from the intense mechanical work and the renewal of the complex oxide surface in intimate contact with the carbon.

A mechanofusion process is described in detail in U.S. Pat. No. 5,789,114. The complex oxide particles or particulate aggregates are brought into contact with a carbon powder, and the mixture is subjected to a mechanical treatment which creates mechanical bonds between the complex oxide particles and the carbon particles. A specific embodiment of the mechanofusion process consists in using carbon particles with GF functional groups, in particular carboxylate or sulfonate groups. Devices for carrying out such a mechanofusion are commercially available, in particular from the companies Hosokawa Micron Group (Japan) and Nara Machinery Co., Ltd. (Japan).

The qualitative determination of the functional groups at the surface of the carbon coating of the complex oxide particles can be carried out by the XPS for oxygenated groups such as COOH, OH and CHO, the phosphonate group and the sulfur-containing groups —SH and —SO₃H (cf. Pantea, D., Darmstadt, H., Kaliaguine, S., Summchen, L., Roy, C., Carbon, vol. 39, pp. 1147-1158, 2001). Degrees of grafting of from 0.0001 to 1 meq of GF functions per gram of grafted material, preferably from 0.001 to 0.2 meq/g, and more particularly from 0.01 to 0.1 meq/g are considered to be efficient. However, the invention is not limited to these degrees. The evaluation of the change in properties (in particular wetting properties, mechanical effect on the composite or detection of converted functions) is a good indicator of whether or not the degree of grafting is sufficient.

A material I according to the invention comprises from 0.1% to 10% of carbon, more particularly from 0.5% to 5%. Depending on the process used for depositing the carbon, the carbon coating is more or less covering and adherent to the surface of the complex oxide particles or particulate agglomerates. The thickness of the carbon coating is generally of the order of a nanometer to a few hundred nanometers. The distribution of the carbon at the surface of the complex oxide and in the mass of the complex oxide can be controlled through the form of the organic precursor: liquid precursor, gas precursor, polymerizable precursor or precursor in organometallic form.

A material I consisting of particles of a complex oxide or particulate aggregates of a complex oxide in which at least part of the surface of the complex oxide particles or particulate aggregates is coated with carbon bonded by chemical bonds and/or physical bonds and, optionally, by mechanical attachment, can be obtained by means of a process characterized in that it comprises:
a) the preparation of complex oxide particles or particulate aggregates such that at least 90% of the particles are between 1 nm and 5 μm in size and at least 90% of the particulate aggregates are between 10 nm and 10 μm in size, said complex oxide corresponding to the formula LiᵢMₘM′_{m′}Z_{z}OₒNₙF_{f} in which:
   Li, O, N, and F represent, respectively, lithium, oxygen, nitrogen and fluorine;
   M represents one or more elements chosen from transition metals;
   M′ represents one or more metals other than a transition metal;
   Z represents at least one element other than a metal;
   the coefficients i, m, m′, z, o, n and f are chosen so as to ensure electroneutrality of the complex oxide, and meet the following conditions:
   i≧0, m>0, z≧0, m′≧0, o>0, n≧0 and f≧0;
b) the deposition of carbon onto at least part of the surface of the complex oxide particles or particulate aggregates or onto at least part of the surface of the precursors of the complex oxide particles or particulate aggregates;
c) the bonding of GF functional groups by formation of a covalent bond with the carbon;
   it being understood that the steps can be carried out successively or simultaneously.

In one embodiment, phases a), b) and c) are carried out in three successive steps. During a 1st step, the complex oxide is prepared. During a second step, the carbonaceous coating is applied to the complex oxide particles or particulate aggregates. During a 3rd step, the carbonaceous particle or particulate aggregates are subjected to treatment aimed at bonding GF functional groups.

The step for preparing the complex oxide can be eliminated for commercially available complex oxides. The preparation of the complex oxides is within the scope of those skilled in the art, in view of the numerous prior art publications (cf. WO-05/062 404, U.S. Pat. No. 5,910,382, U.S. Pat. No. 6,514,640, US-2002/0124386, U.S. Pat. No. 6,855,462 and U.S. Pat. No. 6,811,924).

In a 1st embodiment of the synthesis in three successive steps, which is particularly preferred, the carbonaceous coating is applied by carbonization of a precursor.

In a variant of the 1st embodiment of the synthesis in three successive steps, the precursor is mixed, prior to the carbonization, with carbon particles or fibers, including carbon nanotubes, optionally containing GF groups, in particular sulfonates or carboxylates. A composite carbonaceous coating is thus obtained.

In a 2nd embodiment of the synthesis in three successive steps, the application of the carbonaceous coating can be carried out by mechanofusion.

In another embodiment, the preparation of the complex oxide particles or particulate aggregates and the carbon deposition are carried out simultaneously, and the bonding of the GF groups is obtained on the “carbonaceous complex oxide” material thus obtained. The “carbonaceous complex oxide” material can be obtained, for example, by carrying out the synthesis of the complex oxide from the precursors of the complex oxide and from one or more carbon precursors. The carbon precursor can be chosen in such a way that it also constitutes a complex oxide precursor, for example a salt or an organometallic compound comprising one or more of the constituents of the oxide.

In another embodiment, there is simultaneous formation of a deposit of carbon and GF groups on complex oxide particles or particulate aggregates prepared beforehand. This embodiment is particularly useful when the desired GF groups are carboxylate, hydroxyl, ketone or aldehyde groups. The result is obtained through an appropriate choice of the synthesis and carbonization conditions and of the organic precursors. In a preferred embodiment of the invention, the grafting of the carboxylate, hydroxyl, ketone or aldehyde groups is obtained by oxidation of the carbon with CO₂, optionally in the presence of water vapor. It may be advantageous, in this case, to choose carbon precursors that are more readily oxidizable in order to promote the grafting of the GF groups. The carbon precursor can also be mixed with metal salts that facilitate the oxidation of the carbon coating and that can optionally serve as a doping agent for the complex oxide [cf. “Chemically modified carbon fibers and their applications” I. N. Ermolenko, I. P. Lyubliner, and N. V. Gulko, translated by Tivovets, E. P. (VCH, New-York and Germany, 1990, pp 155-206)].

Steps a), b) and c) of the process for preparing the material I can be carried out simultaneously when the desired GF groups are carboxylate, hydroxyl, ketone or aldehyde groups. The process then consists in preparing a mixture of complex oxide precursors and of a carbon precursor, and in oxidizing C with CO₂.

In the specific case of the titanates Li₄Ti₅O₁₂, which are complex oxides that are stable in the air at high temperatures, the carbonization can be carried out under air or oxygen, optionally in the presence of water vapor, unlike compounds such as LiFePO₄. As a result, it is possible to introduce carboxylate functions or hydroxyl functions by oxidation under air or oxygen at 500-900° C., either of the titanate formed beforehand and subsequently coated with a carbon precursor, or during the synthesis of the titanate, for example by reaction of TiO₂ with LiOH in the presence of a carbon precursor at around 800° C.

The grafting of functional groups onto a carbonaceous material is widely described in the prior art. Reference may, for example, be made to JP-2002/053768, EP-1 078 960, US-2004/138 342, US-2001/036 994, U.S. Pat. No. 6,503,311, US-2003/101 901, US-2002/096 089, US-2004/018 140, US-2003/180 210, US-2004/071 624, and also to “Chemically modified carbon fibers and their applications” I. N. Ermolenko, I. P. Lyubliner, and N. V. Gulko, translated by Tivovets, E. P. [VCH, New York and Germany, 1990, 304 pp], to “Plasma surface treatment in composites manufacturing”, T. C. Chang, [Journal of Industrial Technology, vol. 15, No. 1, November 1998 to January 1999], and to D. Pantea et al., [Applied Surface Science, 217, 2003, pp 181-193]. These documents describe processes for detecting and/or characterizing and/or modifying groups present on the surface of carbon. The characterization of the surface of the carbon is carried out in particular by infrared, mass, XPS, Raman and Auger spectroscopy and by thermogravimetric analysis (TGA).

Certain GF functional groups, hereinafter denoted GF1 groups, can be grafted directly onto a carbonaceous material. As examples of GF1 groups, mention may be made of COOM, CO, CHO and SO₃M (M being an H or an alkali metal) and amino groups. Other GF functional groups, denoted GF2, can be obtained from the GF1 groups by conversion, substitution, addition, condensation or polymerization reactions.

Some examples of processes for bonding GF1 groups and for converting GF1 groups to GF2 groups are given hereinafter purely by way of illustration. Of course, the invention is not limited to these specific cases.

In general, GF1 groups such as the ketone function, the aldehyde function, the quinone function, the —COOH function or the —OH function can be obtained directly on the carbon surface by means of controlled oxidation. An —SO₃H function or an amine function NH₂ can be obtained directly on the carbon surface, for example, by reaction with SO₃ or NH₃.

The above GF1 groups make it possible to bond GF groups that are useful for electrode materials. In addition, —COOH, —OH, —SO₃H, —PO₃H₂, —PO₂H and —NH₂ functions are directly useful as hydrophilic GF groups for the electrode materials.

Many approaches exist for bonding, to a carbonaceous complex oxide, a —CO₂H group in which H can subsequently be replaced by means of cation exchange processes within the scope of those skilled in the art. The bonding of —COOH can be carried out in particular by the following processes:
a) oxidation of the carbonaceous complex oxide with CO₂ at a temperature of 500° C.-900° C.;
b) treatment of the carbonaceous complex oxide with cold plasma under O₂;
c) treatment of the carbonaceous complex oxide with cold plasma under CO₂;
d) diazotation of the carbonaceous complex oxide with a compound carrying a —COOH group, for example aminobenzoic acid;
e) Diels-Alder addition reaction of the carbonaceous complex oxide with an acid containing an unsaturated bond —C═C— or —C≡C—, for example fumaric acid or HCO₂—C≡C—CO₂H;
f) reaction of the carbonaceous complex oxide with maleic anhydride, followed by hydrolysis;
g) addition reaction with a disulfide, a benzotriazole or an azo compound, each of these compounds carrying a —COOH group;
h) reaction with benzoic acid, and then with a nitrite of an organic group so as to obtain a carboxylic acid group;
g) treatment, under argon at 600° C., of a mixture of complex oxide powder and of a dispersion of carbon black carrying —COOH functions, mixed beforehand with an organic precursor, for example in a polyvinyl alcohol/water solution, followed by elimination of the water.

The simultaneous bonding of —OH groups and of —COOH groups can be obtained, for example, by treatment of the carbonaceous complex oxide with water vapor under a stream of a CO/CO₂ mixture at 700° C., or by a cold plasma treatment under O₂.

An —SO₃M group in which M represents H or an alkali metal can be bonded to the carbonaceous surface of the complex oxide by various approaches. M can subsequently be replaced by means of known ion exchange reactions. The following procedures are mentioned by way of examples:
a) reaction of the carbonaceous complex oxide with a disulfide carrying two end —SO₃M groups;
b) reaction of the carbonaceous complex oxide with a benzotriazole carrying an SO₃H group;
c) addition reaction with an azo compound carrying alkali metal sulfonate groups;
d) reaction with benzenesulfonic acid, and then with an alkali metal nitrite so as to obtain an alkali metal sulfonate group, or with a nitrite of an organic group so as to obtain a sulfonic acid group.

An amine group can be bonded to a carbonaceous complex oxide by reaction of the carbonaceous complex oxide with a benzotriazole carrying an amine group; by Diels-Alder addition reaction of the carbonaceous complex oxide with a compound containing an unsaturated bond —C═C— or —C≡C— and carrying at least one amine group; or by the reaction of a diazonium carrying a nitro group (for example, derived from p-aminonitrobenzene), followed by reduction of the —NO₂ to —NH₂.

A ketone, aldehyde or quinone group can be bonded to a carbonaceous complex oxide by reaction of the carbonaceous complex oxide with, respectively, CO₂ or water vapor, or a mixture thereof.

A phosphonate group can be bonded by reaction with PCl₃ followed by hydrolysis, or by reactions similar to those that are implemented with the bonding of a sulfonate group, using precursors carrying phosphonate groups in place of the sulfonate groups (benzotriazole, azo, —C═C—, —C≡C—, diazonium).

In general, the carbonaceous complex oxides carrying GF1 groups of the carboxyl, hydroxyl, sulfonate, phosphonate or amine type can be used for preparing carbonaceous complex oxides carrying GF groups of the GF2 type, by reaction with a compound carrying the GF2 group and a reactive functional group. Examples of reactions involving a GF1 group can be found in table I above.

Many other reactions can also be considered, in particular:
cationic polymerization of a monomer initiated with the —COOH group or an alkali metal carboxylate group, which bonds a polymer group;
the bonding of an azo group to a —COOH group by means of amide bond forms a group for initiating radical polymerization which will subsequently make it possible to initiate a radical polymerization in order to bond to the carbon, a GF group of the polymer type, for example using a vinyl, allyl, acrylic or styrene monomer.
An ion exchange reaction using an appropriate halide makes it possible to replace the initial ion of an ionic group (for example, a —COOLi group or an —SO₃Li group) bonded to the carbon of the carbonaceous complex oxide, with an organic ion comprising the desired GR2 substituent.

Each of the above reactions thus makes it possible to bond, for example, a GF2 group comprising a terminal ethylenic double bond, a terminal epoxy group, or a GF2 group consisting of a polymer segment, optionally carrying a reactive group.

The modification of the surface of a carbonaceous material by grafting of polymer groups is known in particular through N. Tsubokawa [“Functionalization of carbon black by surface grafting of polymers”, Prog. Polym. Sci., 17, 417 (1992)] and [“Functionalization of Carbon Material by Surface Grafting of Polymers”, Bulletin of the Chemical Society of Japan, vol. 75, No 10 (October, 2002)].

A material I according to the present invention, consisting of particles or particulate aggregates of carbonaceous complex oxide carrying GF groups, is particularly useful for the production of composite electrodes, which constitute another subject of the present invention.

A composite electrode according to the invention consists of a composite material deposited onto a current collector, said composite material comprising a material I and, optionally, a binder and/or an agent that confers electron conductivity and/or an agent that confers ionic conductivity.

In a preferred embodiment of the invention, the material I used for the production of the electrode carries GF groups that are hydrophilic in nature.

The compound that confers electron conductivity is preferably chosen from carbon black, acetylene black and graphite, and mixtures thereof. The electron-conducting carbon can be introduced in the form of a powder, of microfibers or of nanotubes, and mixtures thereof.

The compound that confers ionic conductivity can be chosen from the lithium salts used in the electrolytes of lithium batteries, for example LiClO₄, LiPE₆, LiFSI or LiTFSI in solution in an aprotic liquid solvent (such as EC, DEC, DMC, PC, etc.), an ionic liquid solvent (such as, for example, an imidazolium bis(trifluorosulfonyl)imide or a pyrrolidinium fluorosulfonylimide) or a solvating polymer such as, for example, a poly(ethylene oxide) derivative, or a mixture of these solvents used for the production of gelled electrolytes.

In a first embodiment, an electrode according to the invention consists of a composite material deposited onto a current collector, said composite material comprising a material I, a binder and, optionally, an agent that confers electron conductivity.

In a first variant of the first embodiment, the binder is incorporated into the material I by mechanical mixing in the presence of a solvent. The binder is preferably chosen from natural rubbers and synthetic rubbers such as SBR (styrene butadiene rubber), NBR (butadiene-acrylonitrile-rubber), HNBR (hydrogenated NBRs), CHR (epichlorohydrine rubber) and ACM (acrylate rubber) rubbers. In the electrode material, the binder is in contact with most of the surface of the functionalized carbonaceous complex oxide particles or aggregates.

In a second variant of the first embodiment, the material I is incorporated into the binder by dispersion. In this case, the electrode is obtained by means of a process characterized in that:
the material I carries GF groups which are or which carry an FR function for facilitating the dispersion of the functionalized carbonaceous complex oxide particles or aggregates, and GFa groups which are or which carry an FRa functional group capable of reacting by addition or condensation;
the binder carries reactive groups GA capable of reacting by addition or condensation with the FRa groups of the material I;
the particles or particulate aggregates of material I are dispersed in a colloidal suspension of binder nanoparticles;
the dispersion is coated onto a substrate which constitutes the current collector of the electrode;
the dispersion is subjected to a treatment aimed at reacting the FR functions with the GA groups.

The binder is preferably chosen from natural rubbers and synthetic rubbers such as SBR (styrene butadiene rubber), NBR (butadiene-acrylonitrile-rubber), HNBR (hydrogenated NBRs), CHR (epichlorohydrin rubber) and ACM (acrylate rubber) rubbers. An electrode consisting of a layer of composite material on a current collector is thus obtained, said composite material consisting of carbonaceous complex oxide particles or particulate aggregates linked to binder nanoparticles by bonds created by the reaction between the FR functions and the GA groups. The structure of such a composite material is represented schematically in FIG. 5. In FIG. 5, (3) represents the complex oxide particles, (5) represents the carbon coating, (4) represents the current collector and (6) represents the binder nanoparticles.

In a preferred embodiment of the invention, the binder nanoparticles have a diameter <50 nm, and more particularly <25 nm. The binder nanoparticles preferably have a T_{g}<0° C., and more particularly <−20° C. Nanoparticles derived from silicone polymers form a specific category for obtaining polymers with a low T_{g}. Latex-type binders are commercially available and can be obtained by emulsion polymerization of ethylene, acrylic or styrene monomers (cf. U.S. Pat. No. 6,656,633).

In a specific case of the various variants of the first embodiment, the material I also comprises GF groups that are hydrophilic in nature, and that promote its wettability, thereby facilitating the dispersion of the material I in the solvent (organic or aqueous) of the binder suspension.

In a second embodiment, an electrode according to the invention consists of a composite material deposited onto a current collector and comprising a material I which carries GF groups of the polymer type and, optionally, GF groups which are hydrophilic in nature.

In this second embodiment, it is not necessary for the composite material forming the electrode to contain a binder, because the GF groups of the polymer type themselves act as binder. The structural integrity of the electrode during cycling is ensured by the polymeric GF groups. Said polymeric GF groups are chosen for their mechanical and elastomericity properties in order to give the composite electrode mechanical strength and to ensure that the electric contacts are maintained during discharge/charge cycles. The appropriate choice of the monomers used to constitute the polymer group allows, in addition, introduction of other useful functions into the electrode material and thus optimizing the characteristics of the composite electrode. By way of nonlimiting example, the polymers preferably consist of a poly(oxyethylene) segment, which, in the presence of a lithium salt, will act as an electrolytic conductor. Alternatively, the choice of a polymer comprising segments with conjugated double bonds will confer electron conduction properties on the electrode material, which will make it possible to eliminate all or part of the carbon powders generally used as electron conducting additives.

In general, it is within the scope of those skilled in the art to select the appropriate GF groups so as to optimize the energy and power densities of the composite electrode by decreasing the amount of the nonactive material (binder, electron conducting additives, electrolyte, etc.), and also so as to optimize the mechanical properties and the cycling and operating properties thereof.

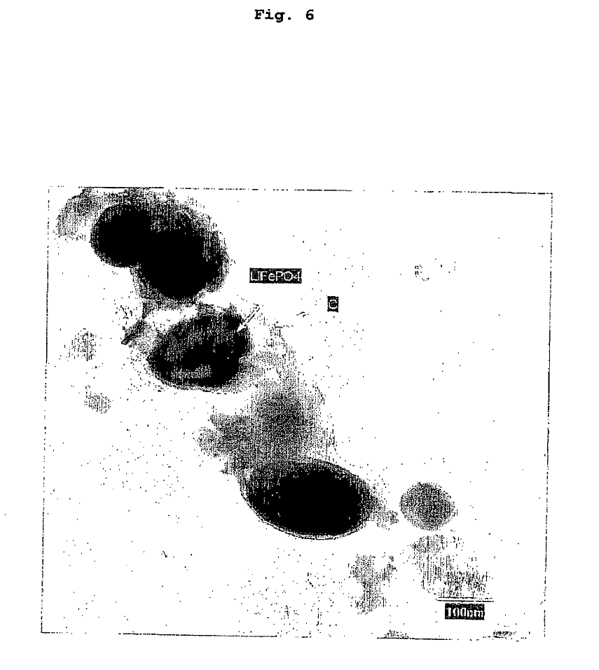

In a third embodiment, an electrode according to the invention consists of a composite material which is deposited onto a current collector and which consists of complex oxide particles coated with carbon and bonded to one another by covalent bonding or ionic bonding. The structure of such a composite material is represented schematically in FIG. 6. In FIG. 6, (3) denotes the complex oxide particles, (5) denotes the carbon coating and (4) denotes the current collector. The complex oxide particles are bonded to one another with a very short distance separating them, by the bonding groups attached to the carbon. Preferably, these bonding groups have elastomer properties in order to ensure that the electrochemical contacts between the components of the composite electrode are maintained. In this third embodiment, the material I carries GR groups consisting of a solvating link and a conjugated link carrying the reactive functional group FR. This embodiment of a composite electrode according to the invention minimizes or eliminates the components other than the complex oxide in order to increase to a maximum the energy density and power density of the composite electrode and of the generator which comprises it.

Such an electrode is obtained by a process characterized in that:
a composite material is prepared from a material I carrying GF groups which are or which carry an FR functional group capable of reacting by addition or condensation with an identical functional group;
the composite material is applied to a substrate which constitutes the current collector of the electrode;
the composite material is subjected to a treatment for reacting the FR functions with one another.

When the complex oxide of the electrode material is LiFe₁₋ₓMgₓPO₄ in which x ranges between 0.1 at. % and 5 at. %, and in particular LiFePO₄, an electrode according to the present invention is particularly useful as a cathode. The functions covalently grafted onto the carbon are, in this case, advantageously chosen from —COOH, >C═O, —OH and —CHO.

When the complex oxide is a titanate of formula LiᵢTiₘM′ₘOₒF_{f}, more particularly Li₄Ti₅O₁₂, an electrode according to the invention is particularly useful as an anode.

The presence of hydrophilic groups (in particular, carboxylic acid, sulfonic acid, sulfonate or carboxylate groups (preferably, lithium sulfonate or lithium carboxylate)) on the surface of the carbon facilitates the dispersion of the complex oxide and the production of composite electrodes, irrespective of whether the preparation is by the solvent approach, including aqueous solvents, or by extrusion. During an extrusion, the presence of these hydrophilic functions reduces the dynamic viscosity of the mixture containing the electron conducting additive and the solvating polymer, thereby facilitating the implementation and improving the electrochemical properties of the electrodes thus obtained. When the binder of the cathode is used in the form of an aqueous colloidal suspension of nanoparticles of polymers (latex), the possibility of obtaining good dispersions of the electrode material makes it possible to prepare electrodes in which the nanoparticles are uniformly distributed at the surface of the complex oxide particles or aggregates, thereby improving the performance levels of the electrodes thus obtained. The presence of hydrophilic groups (in particular, carboxylic acid, sulfonic acid, sulfate or carboxylate groups, preferably lithium sulfonate or lithium carboxylate) on the surface of the carbon facilitates the dispersion of the complex oxide and the production of composite electrodes, irrespective of whether the preparation is by the solvent approach, including aqueous solvents, or by the extrusion approach.

In addition, the hydrophilic groups improve the wettability of the carbonaceous complex oxide particles, which facilitates the penetration of the electrolytes (liquids, ionic liquids, low-molecular-weight solvating polymers) into porous electrodes. The optimization of the formations is thereby facilitated insofar as the surface-carbonaceous complex oxide comprising hydrophilic groups may make it possible to reduce, or even eliminate, the conducting carbon generally used in dispersion with the binder of the composite electrode. The presence of ionic groups such as —COOH, —PO₂H₂, —PO₃H₂, —NH₂, —SO₃H or —OH also enables ion exchanges at the surface of the carbon.

The presence of polymerizable, condensable or crosslinkable GF groups offers many possibilities for optimizing the properties of the binder of the composite electrode. These functions make it possible in particular to chemically attach the particles or particulate aggregates of the active material to the binder of the composite electrode, thus making it possible to minimize the required amounts thereof. The polymerizable GF groups can also directly act as a mechanical binder between the particles in the composite electrode. The polymeric GF groups can thus be chosen so as to add a second useful functional group to the electrode material. For example, a polymeric GF group of poly(ethylene oxide) type makes it possible to act as an electrolyte in the presence of a lithium salt; a polymeric GF group of conjugated type makes it possible both to ensure electron exchanges with the electrode material and to act as mechanical binder of the composite electrode.

The presence of polymeric groups on the electrode material of the presence invention makes it possible to improve the dispersibility of carbonaceous composite oxide particles in organic or aqueous solvents, and also in polymer solvents, depending on the nature of the polymer segments. In certain cases, it is thus possible to obtain ultrafine carbon particle suspensions that are stable over time.

The chemical anchoring of the electrode material to the binder of the composite makes it possible to reduce the amount thereof required for its mechanical strength and its behavior in cycling. The additional role of electrolytic or electron conductor played by the binder and made possible by the present invention makes it possible to optimize the energy and power densities and cyclability of the composite electrodes and of the generators.

It thus appears that the present invention opens up a new approach for producing electrodes which can serve the advantages of the electrodes of the prior art, while at the same time eliminating, or at the very least reducing, their drawbacks. The advantageous redox potentials of the complex oxides are maintained, but without the low electron conductivity. The good electron conductivity provided by the carbon coatings is maintained, without the drawbacks associated with their hydrophobic nature. The good diffusivity of the Li⁺ ions in the very fine particles of complex oxide is maintained, without the poor cohesion of the materials inherent in the small size of the particles. The use of carbonaceous oxides functionalized with crosslinkable groups makes it possible to ensure the cohesion of the material, with an added binder or with very small amounts of added binder, to the benefit of the active material.

These advantages and others will become clearly apparent on reading the following examples which describe specific cases, to which the invention is however not limited.

The present invention is illustrated by the following examples, to which it is not, however, limited.

Examples 1a to 14a describe the preparation of carbonaceous complex oxides modified by grafting of GF1 groups.

Examples 1b to 12b describe the modification of the GF1 functions grafted onto a carbonaceous complex oxide.

Examples 1c to 9c describe the preparation of electrode materials and their use in batteries.

In the examples:
C—LiFePO₄ denotes, in general, a material consisting of particles or particulate aggregates of Li/Fe phosphate with a carbon coating;
C—LiFePO₄(PL) denotes a material consisting of particles or particulate aggregates of Li/Fe phosphate with a carbon coating, said particles having an average size (d₅₀) of 2.7 μm, and which is supplied by Phostech Lithium Inc, Canada;
C—LiFePO₄(Al) denotes a material consisting of particles or particulate aggregates of Li/Fe phosphate with a carbon coating, said particles having an average size (d₅₀) of 2.9 μm, and which is supplied by t Aldrich;
C—Li₄Ti₅O₁₂ denotes, in general, a material consisting of particles or particulate aggregates of Li titanate with a carbon coating;
MC—LiFePO₄ denotes, in general, a material consisting of particles or particulate aggregates of Li/Fe phosphate with a carbon coating with GF groups;
the nanometric titanate Li₄Ti₅O₁₂, the particles of which have a surface area of the order of 130 m²/g, is supplied by Altair nanotechnologies, USA;
the FePO₄.2H₂O is supplied by Budenheim (Germany);
the microporous separator is supplied by Celgard;
the electrolyte LiPF₆ EC:DMC is supplied by Tomiyama Pure Chemicals;
the carbon black FW200 is supplied by Degussa, Germany;
the graphite particles EBN-1010 are sold by Superior Graphite, USA;
the following products used were obtained from the company Aldrich: maleic anhydride, Fe₂O₃(NH₄)₂PO₄, benzotriazole-5-carboxylic acid, glycidyl methacrylate, benzene-1,2,4,5-tetracarboxylic acid, compound Orange G azo carrying SO₃Na groups, lithium thiocyanate 1,3-dicyclohexylcarbodiimide DCC; 1-ethyl-3-methylimidazolium chloride, poly(ethylene glycol) methacrylate Mₙ≈526, 1,2-butoxylate-block-ethoxylate allyl alcohol HLB 6.9, the crown ether 18-crown-6, sodium 4-styrene sulfonate, 3,4-ethylenedioxythiophene (EDOT), bismuth triflate;
Li₂CO₃ is supplied by the company Limtech, Canada;
the acetylene black is supplied by Chevron Phillips Chemical Company;
the 5-aminobenzotriazole is supplied by Lancaster Synthesis Ltd;
the polyalkylene glycol A 20-20 monoallyl ether is supplied by Clariant;
the polyoxyethylene alkylphenyl ether Noigen® RN-40 is supplied by Dai-Ichi Kogyo Seiyaku Co., Japan;
the 1-butyl-1-methylpyrrolidinium is supplied by Merck, Germany;
the 1-diallyldimethylammonium chloride and the (2-methylpropenoyloxyethyl)trimethylammonium chloride are supplied by Ciba Chemical Specialities, Switzerland);
Jeffamin M-2070 (ethylene oxide/propylene oxide monoamine copolymer), Surfonamine® L-300 (polyether monoamine) and the poly(oxyethylene)diamine XTJ-502 having an M_{w}=2130 are sold by Huntsman, USA;
Tyzor TPT® (tetraisopropyl titanate) sold by Dupont;
the epichlorohydrin is supplied by ABCR GmbH & Co. KG;
the 2,2′-azobis[2-methyl-N-(2-hydroxyethyl)propion-amide]chloride and the 2,2-azobis[2-(2-imidazolin-2-yl)propane]chloride are supplied by the company Wako, Japan, and are converted to the bis(trifluoromethane-sulfonyl)imide salt by ion exchange in water;
the polyethylene glycol (600) diacrylate is supplied by Sartomer, France;
the polyoxazoline EPOCROS WS-700 is supplied by Nippon Shokubai, Japan;
the modified styrene-butadiene copolymer LHB-108P is produced by LICO Technology Corp., Taiwan, and sold by Pred Materials International Inc., USA);
the aziridine is supplied by ABCR GmbH & Co, KG;
the latex BM-400B is produced by Zeon Corporation, Japan.

### EXAMPLE 1A

200 g of C—LiFePO₄(PL) are treated for 24 hours under reflux in a solution of 20 g of maleic anhydride in 600 ml of toluene. The product recovered after filtration is washed several times with toluene and then dried under vacuum at 80° C. for 24 h. An MC—LiFePO₄ material carrying anhydride groups —C(═O)—O—C(═O)— was obtained.

Part of this material was treated with an aqueous solution of LiOH so as to give an MC—LiFePO₄ material carrying —COOLi groups, and another part of this material was treated with an aqueous solution of KOH so as to give an MC—LiFePO₄ material carrying —COOK groups.

### EXAMPLE 2A

100 g of C—LiFePO₄(PL) were introduced into an aqueous solution containing 5 g of disulfide LiSO₃-φ-S—S-φ-SO₃Li and the whole was carefully mixed. After removal of the water, the product was heated for 4 h at 180° C. under argon and then Soxhlet-washed under argon overnight and then dried under vacuum at 80° C. for 24 h. An MC—LiFePO₄ material with lithium sulfonate groups was obtained.

### EXAMPLE 3A

LiFePO₄ was prepared by melting 1 mol of Fe₂O₃, 2 mol of (NH₄)₂HPO₄ and 1 mol of Li₂CO₃ in a graphite crucible at 1000° C. under argon for 1 h. LiFePO₄ with a degree of purity of 94% (determined by DRX) was obtained.

This compound was subsequently converted to particles having a size of 2 μm in a planetic mill. The powder obtained was mixed in an aluminum mortar, with 4% by weight of acetylene black, and the mixture was then treated by mechanofusion at 1000 rpm for 1 hour so as to produce a C—LiFePO₄ material carrying an acetylene black coating. The C—LiFePO₄ material was then treated for 2 h at 700° C. with water vapor under a CO/CO₂ gas stream. An MC—LiFePO₄ carrying —OH groups and —COOH groups was then obtained.

### EXAMPLE 4A

The protocol of example 3a was reproduced using 3% by weight of carbon black FW200 instead of 4% of acetylene black. An MC—LiFePO₄ carrying —COOH groups was thus obtained.

### EXAMPLE 5A

An LiFePO₄ powder was prepared according to the protocol of example 3, and this powder was then mixed with a dispersion of carbon black FW200 in an aqueous solution of PVA, the amount of FW200 and the amount of PVA representing, respectively, 2% and 5% by weight of the amount of LiFePO₄. After elimination of the water, the residual mixture was treated at 600° C. for 1 h under argon. An MC—LiFePO₄ carrying —COOH groups was obtained.

### EXAMPLE 6A

50 g of C—LiFePO₄(Al) were microwave plasma-treated (2.45 GHz, 300 W) for 30 seconds under a pressure of 1 mbar of pure O₂. An MC—LiFePO₄ carrying —COOH and —OH groups was obtained.

### EXAMPLE 7A

### Sample 1

An LiFePO₄ powder was mixed, in an aluminum mortar, with 4% by weight of acetylene black, and the mixture was then subjected to mechanofusion with a rotation speed of 1000 rpm, so as to obtain a C—LiFePO₄. 50 g of material were then refluxed for 8 h in 300 ml of a degassed aqueous solution containing 2 g of δ-(1-benzotriazolyl)butanesulfonic acid. The residue obtained after filtration was washed several times with water, and an MC—LiFePO₄ carrying —SO₃H groups was obtained.

### Sample 2

The process of sample 1 was carried out, but replacing the δ-(1-benzotriazolyl)butanesulfonic acid with benzotriazole-5-carboxylic acid, and MC—LiFePO₄ carrying —COOH groups was obtained.

### Sample 3

The process of sample 1 was carried out, replacing the δ-(1-benzotriazolyl)butanesulfonic acid with 5-amino-benzotriazole, and MC—LiFePO₄ carrying amino groups was obtained.

### Samples 4 to 6

The process of each of samples 1 to 3 above was carried out, but using the C—LiFePO₄(PL) material in place of the C—LiFePO₄ material prepared in situ, so as to obtain MC—LiFePO₄ materials carrying, respectively, SO₃H, —COOH and amino groups.

### EXAMPLE 8A

LiFePO₄ was prepared by precipitation using LiH₂PO₄, Fe(SO₄)₂*7H₂O and LiOH as precursors, as described in example 4 of US 2004/0151649. The LiFePO₄ material obtained was impregnated with lactose, and the product was then subjected to carbonization by heat treatment consisting in heating from ambient temperature to 725° C. at a rate of 3° C./min under a nitrogen atmosphere, and maintaining the temperature at 725° C. under nitrogen for 12 h. 200 g of the C—LiFePO₄ compound were introduced into water and the product was mixed for 30 min with 5 g of an Orange G azo compound comprising SO₃Li groups (obtained by ion exchange from the Orange G azo compound carrying SO₃Na groups). After evaporation of the solvent, the product was irradiated three times for 1 min in a microwave oven at 700 W. The MC—LiFePO₄ material obtained was then washed overnight in a Soxhlet extractor, and then dried under vacuum at 80° C. for 24 h. The material obtained carries SO₃Li groups. The above protocol was also carried out with azobenzene-4-carboxylic acid, so as to obtain an MC—LiFePO₄ material carrying —COOH groups.

### EXAMPLE 9A

### 1st Sample

100 g of C—LiFePO₄(PL) was refluxed in 500 ml of water with stirring, 17.3 g of 4-aminobenzenesulfonic acid were added, and then 17.3 g of potassium nitrite were added in several steps. After refluxing for 30 min, the reaction medium was cooled and centrifuged. The product recovered was washed several times with water in an ultrasonic bath, and then dried under vacuum at 80° C. for 24 h. An MC—LiFePO₄ material carrying —SO₃K groups was obtained.

### 2nd Sample

The protocol of the 1st sample was reproduced using 13.7 g of 4-aminobenzoic acid, and an MC—LiFePO₄ material carrying —CO₂K groups was obtained.

### 3rd Sample

The protocol of the 1st sample was reproduced, using lithium nitrite. An MC—LiFePO₄ material carrying —SO₃Li groups was obtained.

### 4th Sample

The protocol of the 1st sample was reproduced, using 13.7 g of 4-aminobenzoic acid and lithium nitrite, and an MC—LiFePO₄ material carrying —CO₂Li groups was obtained.

For each of the samples obtained above, 500 mg was introduced into 10 ml of water and the mixture was treated with ultrasound for 2 min. The dispersion obtained remains stable after 5 min, whereas an untreated material separated out.

### EXAMPLE 10A

### 1st Sample

A C—Li₄Ti₅O₁₂ material was prepared by the sol-gel technique using titanium tetra(isopropoxide) (28.42 g) and dehydrated lithium acetate (35.7 g in 300 ml of an 80:20 isopropanol-water mixture). The resulting white gel was dried in an oven at 80° C. and calcinated at 800° C. in air for 3 hours, and then under argon comprising 10% of hydrogen, at 850° C. for 5 hours. 10 g of the resulting powder were mixed into 12 ml of a 13% by weight solution of cellulose acetate in acetone. The paste was dried and the polymer was carbonized under an inert atmosphere at 700° C.

### 2nd Sample

The protocol of the 1st sample was reproduced, using a nanometric titanate Li₄Ti₅O₁₂ (130 m²/g) in place of that obtained by the sol-gel process, so as to prepare a C—Li₄Ti₅O₁₂ material.

The 4 samples of example 9a were reproduced, replacing C—LiFePO₄(PL) with the C—Li₄Ti₅O₁₂ material obtained using the above two processes, so as to obtain MC—Li₄Ti₅O₁₂ materials carrying, respectively, SO₃K, COOK, SO₃Li and COOLi groups.

### EXAMPLE 11A

100 g of C—LiFePO₄(PL) in 500 ml of water was refluxed with stirring, 4.3 g of 4-aminobenzenesulfonic acid and 3.4 g of benzoic acid were added, followed by 4.3 g of potassium nitrite in several steps. After refluxing for 30 min, the reaction medium was cooled and centrifuged. The product recovered was washed several times with water in an ultrasonic bath, and then dried under vacuum at 80° C. for 24 h. An MC—LiFePO₄ material carrying —SO₃K groups and —COOK groups was obtained.

### EXAMPLE 12A

### 1st Sample

100 g of C—LiFePO₄(PL) in 500 ml of water were refluxed with stirring, and 17.3 g of 4-aminobenzenesulfonic acid were added, followed by 20 ml of tert-butyl nitrite in 15 min. After refluxing for 30 min, the reaction medium was cooled and centrifuged. The product recovered was washed several times with water in an ultrasonic bath, and then dried under vacuum at 80° C. for 24 h. An MC—LiFePO₄ material carrying —SO₃H groups was obtained.

### 2nd Sample

The protocol of the 1st sample was reproduced, using 13.7 g of 4-aminobenzoic acid, and an MC—LiFePO₄ material carrying —CO₂H groups was obtained.

### 3rd Sample

The protocol of the 1st sample was reproduced, using 5-aminobenzene-1,3-carboxylic acid. An MC—LiFePO₄ material carrying —CO₂H groups was obtained.

### EXAMPLE 13A

The 3 samples of example 12a were reproduced, replacing C—LiFePO₄(PL) with C—Li₄Ti₅O₁₂ prepared according to the protocol described in example 10a, so as to obtain MC—Li₄Ti₅O₁₂ materials carrying, respectively, SO₃H and COOH groups.

### EXAMPLE 14A

200 g of C—LiFePO₄(PL) in 600 ml of water were refluxed for 24 h with stirring, in the presence of 20 g of acetylenedicarboxylic acid monolithium salt. The product recovered by filtration was washed several times with water, and then dried under vacuum at 80° C. for 24 h An MC—LiFePO₄ material carrying —COOLi groups and —COOH groups was obtained.

### EXAMPLE 15A

The protocol of example 12a was reproduced, using various aminobenzene derivatives instead of the 4-aminobenzenesulfonic acid. An MC—LiFePO₄ carrying the groups identified in the following table was thus obtained:

| Precursors | Grafted species |
|---|---|
| p-H₂N-φ-F | C-φ-F |
| p-H₂N-φ-Cl | C-φ-Cl |
| p-H₂N-φ-Br | C-φ-Br |
| p-H₂N-φ-NO₂ | C-φ-NO₂ |
| p-H₂N-φ-CO₂CH₃ | C-φ-CO₂CH₃ |
| p-H₂N-φ-CO₂C₂H₅ | C-φ-CO₂C₂H₅ |
| p-H₂N-φ-OH | C-φ-OH |
| p-H₂N-φ-tert-butyl | C-φ-tert-butyl |
| p-H₂N-φ-OC₈H₁₇ | C-φ-OC₈H₁₇ |
| 1-aminoanthraquinone | C-φ-1-aminoanthraquinone |
| 4′-aminobenzo-15-crown-5 | C-benzo-15-crown-5 |

The samples were reproduced, replacing C—LiFePO₄(PL) with the C—Li₄Ti₅O₁₂ material, prepared according to the two protocols described in example 10a, so as to obtain MC—Li₄Ti₅O₁₂ materials carrying, respectively, the groups described in the above table.

### EXAMPLE 16A

### 1st Sample

0.1 mol of FePO₄.2H₂O, 0.05 mol of lithium carbonate and 672 mg of a terpolymer (acrylonitrile, methacrylate, itaconic acid, 93:5.7:1.3) in solution in 50 ml of dimethylformamide were mixed in a mortar. After drying, the mixture was subjected to carbonization by means of a heat treatment consisting in heating from ambient temperature to 725° C. at a rate of 3° C./min under a CO/CO₂ atmosphere, and maintaining the temperature at 725° C. under nitrogen for 12 h. An MC—LiFePO₄ material carrying —COOH groups and —OH groups was obtained.

### 2nd Sample

The protocol of the 1st sample was reproduced, substituting the polymer in solution in DMF with a solution of 1 g of cellulose acetate in 20 ml of a 5% by weight solution of LiSCN, and an MC—LiFePO₄ material carrying —CO₂H groups and —OH groups was obtained.

### EXAMPLE 1B

10 g of an MC—LiFePO₄ carrying carboxyl groups were dispersed in 50 ml of a solution of 4 g of polyalkylene glycol A 20-20 monoallyl ether. The mixture was cooled to 0° C. and then 5 ml of a solution of 200 mg of 1,3-dicyclohexylcarbodiimide (DCC) in ethyl acetate were added slowly in 30 min, followed by pyridine as catalyst. The reaction mixture was kept stirring overnight. The powder recovered after filtration was washed several times with ethyl acetate and with water. The MC—LiFePO₄ obtained carries allyl groups.

The above protocol was repeated, replacing the A20-20 ether successively with 2 mmol of the following compounds: allyl alcohol, 1,6-hexanediol vinyl ether, 2-hydroxyethyl methacrylate, N-(hydroxylmethyl)acrylamide, N-(4-hydroxyphenyl)maleimide, polyoxyethylene alkylphenyl ether Noigen® RN-40. The MC—LiFePO₄ materials obtained carry, respectively, allyl groups, vinyl ether groups, methacrylate groups, acrylamide groups, maleimide groups and CH₃—CH═CH-φ- groups, which are polymerizable groups.

### EXAMPLE 2B

2 g of an MC—LiFePO₄ carrying —SO₃Li groups were reacted with 100 mg of a 1-ethyl-3-methylimidazolium (EMI) chloride. After filtration, the product was washed several times with water. The treatment was repeated five times, and the product was then dried under vacuum at 80° C. The MC—LiFePO₄ material obtained carries EMI sulfonate groups.

The above protocol was repeated, using 1-butyl-1-methylpyrrolidinium (BMP) chloride, and an MC—LiFePO₄ carrying BMP sulfonate groups was obtained.

### EXAMPLE 3B

2 g of an MC—LiFePO₄ carrying —SO₃Li groups were reacted, in water, with 100 g of a diallyldimethylammonium (DADMA) chloride. After filtration, the product was washed several times with water. The treatment was repeated five times, and the product was then dried under vacuum at 80° C. The MC—LiFePO₄ material obtained carries allyl groups.

The above protocol was repeated, using (2-methylpropenoyloxyethyl)trimethylammonium (META) chloride, and an MC—LiFePO₄ bearing methacrylate groups was obtained.

### EXAMPLE 4B

### 1st Sample

20 g of Jeffamine M-2070 were dissolved in 200 ml of ethyl acetate and then 20 g of an MC—LiFePO₄ with carboxylic groups were dispersed in the solution obtained. A solution of 400 g of 1,3-dicyclohexylcarbodiimide in 5 ml of ethyl acetate was then added slowly in 30 min. The reaction mixture was stirred at ambient temperature for 24 h and then filtered. The powder obtained was washed several times with ethyl acetate and with water. The MC—LiFePO₄ material thus obtained carries Jeffamine M-2070 groups bonded by an amine bond.

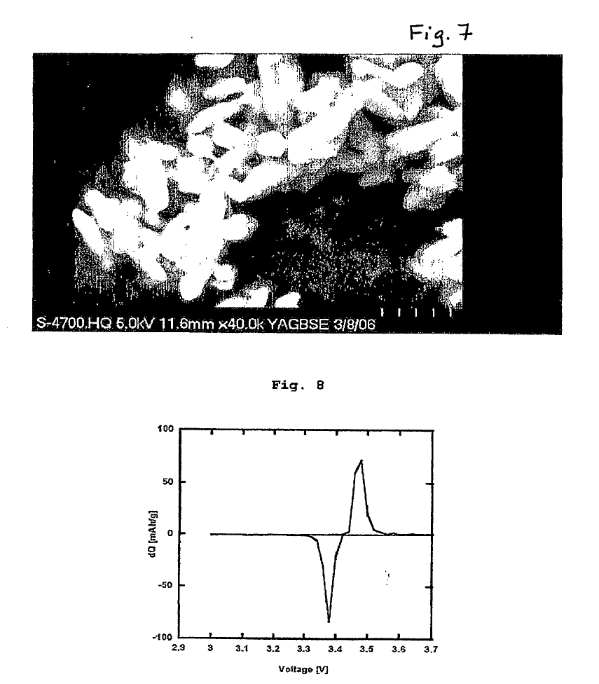

50 mg of this product were then treated with 1 ml of a solution of 1 g of bismuth triflate in 20 cc of isopropanol, and the product was then washed several times with isopropanol and finally dried. The bismuth solvated by the poly(ethylene oxide) chain serves as a marker and it is thus possible to observe, on an electron microscope, the presence of polymers in the form of white spots, as can be seen in FIG. 7.

### 2nd Sample

The protocol of the 1st sample was repeated, using 20 g of the compound sold under the name Surfonamine® L-300. An MC—LiFePO₄ material carrying Surfonamine® L-300 groups bonded by an amine bond was obtained.

### 3rd Sample

The protocol of the 1st sample was repeated, using a C—Li₄Ti₅O₁₂ material. An MC—Li₄Ti₅O₁₂ material carrying Jeffamine M-2070 groups bonded by amide bonds was obtained.

### EXAMPLE 5B

### 1st Sample

In a Dean-Stark apparatus, 100 g of MC—LiFePO₄ carrying —COOH groups and 10 g of poly(ethylene glycol) methacrylate (Mₙ≈526) in 600 ml of toluene were refluxed, with stirring. After 1 h, 100 mg of Tyzor® TPT were added through a septum and the reaction medium was left to reflux overnight. The product recovered by filtration was washed several times in water, and then dried under vacuum at ambient temperature for 48 h. An MC—LiFePO₄ material carrying methacrylate groups was obtained.

### 2nd Sample

The protocol of the 1st sample was reproduced, using 10 g of allyl alcohol 1,2-butoxylate-block-ethoxylate HLB 6.9. An MC—LiFePO₄ material carrying allyloxy groups was obtained.

### 3rd Sample

The protocol of the 1st sample was reproduced, using a C—Li₄Ti₅O₁₂ material, and an MC—Li₄Ti₅O₁₂ material carrying methacrylate groups was obtained.

### 4th Sample

The protocol of the 2nd sample was reproduced, using a C—Li₄Ti₅O₁₂ material, and an MC—Li₄Ti₅O₁₂ material carrying allyloxy groups was obtained.

### 5th Sample

The protocol of the 1st sample was reproduced, replacing the poly(ethylene glycol) methacrylate with Jeffamin M-2070. An MC—LiFePO₄ material carrying Jeffamine M-2070 groups bonded by an amide bond was obtained.

### 6th Sample

The protocol of the 1st sample was reproduced, replacing the poly(ethylene glycol) methacrylate with Surfonamine® L-300. An MC—LiFePO₄ material carrying Surfonamine® L-300 groups bonded by an amide bond was obtained.

### EXAMPLE 6B

10 g of MC—LiFePO₄ carrying hydroxyl groups were dispersed in 50 ml of dichloromethane, and the mixture was reacted for 24 h with 1 g of epichlorohydrin in the presence of 1 ml of pyridine. The product recovered by filtration was washed several times with dichloromethane, and then dried under vacuum at ambient temperature for 48 h. The MC—LiFePO₄ material obtained carries epoxy groups.

### EXAMPLE 7B

### 1st Sample

10 g of MC—LiFePO₄ carrying carboxyl groups were dispersed in 50 ml of a dioxane/n-heptane mixture (60/40 by vol), and the mixture was reacted for 4 h with 1 g of glycidyl methacrylate in the presence of 200 μl of triethylamine. The product recovered by filtration was washed several times with a dioxane/n-heptane mixture, and then dried under vacuum at ambient temperature for 48 h. The MC—LiFePO₄ material obtained carries methacrylate groups.

### 2nd Sample

The protocol of the 1st sample was reproduced, using 10 g of C—Li₄Ti₅O₁₂ carrying carboxyl groups, and an MC—Li₄Ti₅O₁₂ material carrying methacrylate groups was obtained.

### EXAMPLE 8B

10 g of MC—LiFePO₄ carrying carboxyl groups and 1 g were dispersed in 50 ml of ethyl acetate, and the mixture was reacted for 4 h with 1 g of 2,2′-azobis[2-methyl-N-(2-hydroxyethyl)propionamide] (supplied by Wako Pure Chemical Industries, Japan). The mixture was cooled to 0° C., and then 800 mg of 1,3-dicyclohexylcarbodiimide in solution in 5 ml of ethyl acetate were added slowly in 30 min, followed by 40 mg of 4-dimethylaminopyridine as catalyst. Grafting by means of an ester bond of the 2,2′-azobis[2-methyl-N-(2-hydroethyl)propionamide] was thus obtained.

The product recovered by filtration was washed several times with ethyl acetate and with water, and then dried under vacuum at ambient temperature for 24 h. The MC—LiFePO₄ material obtained carries azo groups which can initiate a radical polymerization.

### EXAMPLE 9B

10 g of the MC—LiFePO₄ material carrying azo groups, obtained according to the process of example 8b, and 2 g of glycidyl methacrylate were dispersed in 50 ml of dimethylformamide (DMF). An argon stream was passed through the reaction medium for 1 h, followed by heating at 100° C. for 3 h.

The product recovered by filtration was washed several times with DMF and with acetone, and then dried under vacuum at ambient temperature for 24 h. The MC—LiFePO₄ material obtained carries polyacrylate groups which have epoxy side groups.

### EXAMPLE 10B

10 g of the MC—LiFePO₄ material carrying COOK groups, 1.42 g of glycidyl methacrylate and 20 mg of 18-crown-6 were dispersed in 30 ml of dimethylformamide (DMF) in a glove box under argon. The reaction medium was heated at 100° C. for 4 h, with stirring.

The product recovered by filtration was washed several times with DMF and with acetone, and then dried under vacuum at ambient temperature for 24 h. The MC—LiFePO₄ material obtained carries polyester groups which have methacrylate side groups.

### EXAMPLE 11B

2.18 g of benzene-1,2,4,5-tetracarboxylic acid dianhydride were mixed, in 200 ml of toluene, with 24 g of a poly(oxyethylene)diamine XTJ-502 having a molecular mass M_{w}=2130. After refluxing for 24 h in a Dean-Shark apparatus, 50 g of an MC—LiFePO₄ carrying carboxyl groups were added. The mixture was refluxed for a further 60 min, and then 500 mg of Tyzor TPT were added through a septum, and the reaction was allowed to continue under reflux overnight. The powder obtained by centrifugation was washed several times with toluene, and then dried under vacuum at ambient temperature for 48 h. An MC—LiFePO₄ material carrying poly(benzene-1,2,4,5-tetracarboxylic acid dianhydride-co-polyoxyethylenediamine) redox polymer groups was thus obtained.

### EXAMPLE 12B

2.18 g of benzene-1,2,4,5-tetracarboxylic acid dianhydride were mixed, in 200 ml of toluene, with 24 g of poly(oxyethylene)diamine XTJ-502. After refluxing for 24 h in a Dean-Stark apparatus, 50 g of an MC—LiFePO₄ carrying carboxyl groups were added. The mixture was refluxed for a further 60 min, and then 500 mg of Tyzor TPT were added through a septum, and the reaction was allowed to continue under reflux overnight. The powder obtained by centrifugation was washed several times with toluene, and then dried under vacuum at ambient temperature for 48 h. An MC—LiFePO₄ material carrying poly(benzene-1,2,4,5-tetracarboxylic acid dianhydride-co-polyoxyethylenediamine) redox polymer groups was thus obtained.

### EXAMPLE 1C

### 1st Sample

In a glove box, the following were mixed in 15 ml of ethyl acetate: 3 g of MC—LiFePO₄ prepared according to example 1b; 250 mg of EBN-1010 graphite particles; 1.7 g of a terpolymer of ethylene oxide, methylglycidyl ether and allylglycidyl ether (molar ratio 80:15:5); and 500 mg of polyethylene glycol (600) diacrylate. This mixture was stirred at ambient temperature for approximately 12 h, and then 17.5 mg of a compound obtained by ion exchange between LiTFSI and 2,2′-azobis[2-(2-imidazolin-2-yl)propane]bis(trifluoromethanesulfonyl)imide (TFSI) were added and the mixture was stirred for 90 min.

The composition thus obtained is applied, in the form of a film 30 μm thick, to an aluminum strap (which will serve as a current collector for an electrode), and then heated under an inert atmosphere at 80° C. for 24 h. An electrode (cathode) for a battery, comprising an MC—LiFePO₄ in an interpenetrated network formed between the MC—LiFePO₄ and polymers, is thus obtained.

### 2nd Sample

The protocol used for the 1st sample was reproduced, using an MC—Li₄Ti₅O₁₂ material carrying allyl groups. An electrode (anode) for a battery, comprising an MC—Li₄Ti₅O₁₂ in an interpenetrated network formed between the MC—Li₄Ti₅O₁₂ and polymers, is thus obtained.

### EXAMPLE 2C

A mixture containing 8 g of an MC—LiFePO₄ carrying carboxyl groups, 1 g of EBN-1010 graphite particles and an aqueous solution containing 4 g of polyoxazoline Epocros WS-700 was prepared.

The composition thus obtained is applied, in the form of a film 60 μm thick, to a substrate and then heated under an inert atmosphere at 120° C. for 1 h. A cathode for a lithium-ion battery, in which the binder is linked to MC—LiFePO₄ by means of a bond formed by reaction of the oxazoline and —COOH groups, is thus obtained.

### EXAMPLE 3C

### 1st Sample

A mixture containing 1.8 g of water, 2.82 g of an MC—LiFePO₄ carrying COOH groups and OH groups, 12 mg of EBN-1010 graphite particles and an aqueous suspension containing 40 mg of a modified styrene-butadiene copolymer LHB-108P was prepared.

The composition thus obtained is applied, in the form of a film 50 μm thick, to a substrate and then heated in air at 60° C. for 2 h, and then under an inert atmosphere at 80° C. for 24 h. A cathode for a battery is also obtained.

### 2nd Sample

The protocol of the 1st sample was repeated, using an MC—Li₄Ti₅O₁₂ material carrying —SO₃Li groups, so as to prepare a cathode material.

### EXAMPLE 4C

10 g of an MC—LiFePO₄ material carrying COOH groups and 1 g of freshly distilled aziridine were dispersed in 50 ml of tetrahydrofuran (THF), and the mixture was reacted for 24 h at 50° C. with stirring. The product recovered by filtration was washed several times with THF, and then dried under vacuum at ambient temperature for 24 h. The MC—LiFePO₄ material obtained carries amino groups.

A dispersion of 300 mg of poly(glycidyl methacrylate) nanoparticles, 10-20 nm in diameter, in 5 ml of water was prepared by emulsion polymerization using the method described in “Synthesis and curing of poly(glycidyl methacrylate) nanoparticles, Jyonsik Jang, Joonwon Bae, Sungrok Ko, Journal of Polymer Science Part A: Polymer Chemistry, Volume 43, Issue 11, 2005, pages 2258-2265”.

A mixture containing 10 g of the MC—LiFePO₄ carrying amino groups, 1 g of EBN-1010 graphite particles and the dispersion of poly(glycidyl methacrylate) nanoparticles was prepared.

The composition thus obtained is applied, in the form of a film 60 μm thick, to a substrate and then heated at 120° C. in dry air for 1 h. A cathode material for a lithium-ion battery, in which the MC—LiFePO₄ material is bonded to a polymer by means of the bond formed between an epoxy group and an amino group, is thus obtained.

### EXAMPLE 5C

10 g of an MC—LiFePO₄ material carrying azo groups, obtained according to the process of example 8b, and 1 g of 4-styrenesulfonic acid (obtained from sodium 4-styrenesulfonate) were dispersed in 50 ml of water. A stream of argon was passed through the reaction medium through a septum for 1 h, and then the reaction medium was heated at 70° C. for 4 h.

The product recovered by filtration was washed several times with water, and then dried under vacuum at ambient temperature for 24 h. The MC—LiFePO₄ material obtained carries poly(sulfonic acid) groups.

This material was dispersed, with stirring, in 50 ml of water containing 1 g of 3,4-ethylenedioxythiophene (EDOT). After 5 min, 2 g of ammonium persulfate were added. After reaction for 24 h at 30° C., a powder was recovered and was washed several times with water and with methanol and then dried under vacuum for 24 h at ambient temperature. An MC—LiFePO₄ material which carries [poly(3,4-ethylenedioxy-thiophene)/poly(styrenesulfonate)] PEDT/PSS polymer groups, which have an intrinsic conductivity, was thus obtained.

### EXAMPLE 6C

LiFePO₄ doped with molybdenum was synthesized by melting, for one hour, under argon at 1000° C. and in a graphite crucible, 1 mol of Fe₂O₃, 2 mol of (NH₄)₂HPO₄, 1 mol of Li₂CO₃ and 0.06 mol of Li₂MoO₄. The LiFePO₄ doped with molybdenum, LiFeMoPO₄ (94% purity by X-rays), was subsequently milled to an average size of 1 μm. 50 g of the LiFeMoPO₄ powder was subsequently mixed in a mortar with 2.5 g of cellulose acetate in solution in water. After evaporation of the water, the product was carbonized under CO₂ at 800° C. for 4 h. An MC—LiFeMoPO₄ material which carries —COOH and —OH groups was obtained. 10 g of MC—LiFeMoPO₄ were then treated in THF for 8 h with tolylene 2,4-diisocyanate-terminated poly(propylene glycol) (Mₙ˜2300, product from Aldrich; 3 g), and then Soxhlet-washed for 24 h in THE. An MC—LiFeMoPO₄ which carries isocyanate groups was thus obtained. 10 g of this MC—LiFeMoPO₄ was then mixed with 1 g of EBN-1010 graphite in THF. Prior to the coating, 20 mg of trimethylolpropane ethoxylate (M_{w}=730, product from Aldrich; 20 mg) were added to the solution. After having been poured onto a Teflon plate in a glove box, the film was heated at 60° C. for 2 h. A self-supporting cathode with linkages obtained by reaction of isocyanates with the —OH functions was thus obtained.

### EXAMPLE 7C

A mixture of MC—LiFePO₄ with —SO₃Li functions (36% by weight), as prepared in example 9a, of polyethylene oxide) of mass 100 000 (59% by weight) of EBN-1010 graphite (2.5% by weight) and of Shawinigan black (2.5% by weight) was introduced into a mixer (Haake Rheocorder). The mixing was then carried out at 100° C. with a speed of 50 rpm while recording the torque (N.m). A similar test was carried out, replacing the MC—LiFePO₄ carrying —SO₃Li functions with the untreated C—LiFePO₄ homolog. It was thus possible to demonstrate the beneficial effect of the presence of the —SO₃Li groups through the decrease in the couple measured, indicating that the mixture could be more readily used by extrusion.

### EXAMPLE 8C

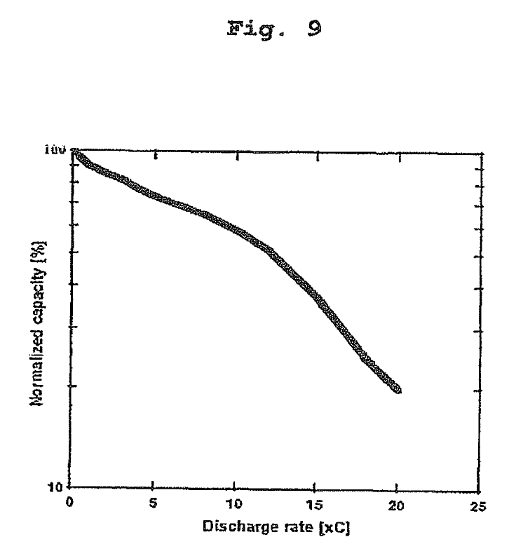

A button cell was assembled in a glove box using a cathode as prepared in the first sample of example 1c, an electrolyte film of poly(ethylene oxide) 5×10⁶ containing 30% by weight of LiTFSI and a lithium disk as anode. The battery was tested using a VMP2 potentiostat (Bio-Logic—Science Instruments) at 80° C. and with a scanning rate of 20 mV/h between 3 and 3.7 V vs. Li⁺/Li⁰. The corresponding cyclic voltametry is given in FIG. 8.

### EXAMPLE 9C

A button cell was assembled with a composite cathode as prepared in example 4c, a 25 μm separator made of Celgard®, a lithium metal anode and an electrolyte of 1M LiPF₆ in EC:DMC (1:1) impregnating the whole. A first cyclic voltametry between 3 V and 3.7 V vs. Li⁺/Li⁰ was carried out at ambient temperature in order to determine the capacity of the electrode. Intensiostatic power studies were then carried out in order to determine the energy/power characteristic of the battery as described in FIG. 9.

1. An electrode material consisting of particles or particulate aggregates of a complex oxide which has redox properties and which can reversibly insert the lithium cation, in which at least part of the surface of the complex oxide particles or particulate aggregates is coated with a carbon layer bonded by chemical bonds and/or physical bonds and, optionally, by mechanical attachment, characterized in that:
a) the complex oxide corresponds to the formula
LiᵢMₘM′_{m′}Z_{z}OₒNₙF_{f} (I)
in which:
Li, O, N and F represent, respectively, lithium, oxygen, nitrogen and fluorine;
M represents one or more elements chosen from transition metals;
M′ represents one or more metals other than a transition metal;
Z represents at least one non-metal;
the coefficients i, m, m′, z, 0, n and f are chosen so as to ensure electroneutrality of the complex oxide, and meet the following conditions:
i≧0, m>0, z≧0, m′≧0, o>0, n≧0 and f≧0;
b) the carbon carries covalently bonded functional groups GF;
c) the size of the particles and particulate aggregates of carbonaceous complex oxide is such that at least 90% of the particles are between 1 nm and 5 μm in size, and if the particles are present in the form of aggregates, at least 90% of the particulate aggregates are between 10 nm and 10 μm in size.

2. The material as claimed in claim 1, characterized in that M represents one or more transition metals M1 chosen from iron, manganese, vanadium and titanium.

3. The material as claimed in claim 2, characterized in that the metal(s) M1 is (are) partially replaced with one or more transition metals M2 chosen from molybdenum, nickel, chromium, cobalt, zirconium, tantalum, copper, silver, niobium, scandium, zinc and tungsten, the ratio by weight of the metals M1 to the metals M2 being greater than 1.

4. The material as claimed in claim 1, characterized in that the metal M′ is chosen from Li, Al, Ca, Mg, Pb, Ba, In, Be, Sr, La, Sn and Bi.

5. The material as claimed in claim 1, characterized in that the non-metal element Z is chosen from S, Se, P, As, Si and Ge.

6. The material as claimed in claim 1, characterized in that the complex oxide corresponds to general (I) LiᵢMₘM′_{m′}Z_{z}OₒNₙF_{f} in which i>0.

7. The material as claimed in claim 1, characterized in that the complex oxide corresponds to the formula LiᵢMₘM′ₘOₒNₙF_{f}.

8. The material as claimed in claim 7, characterized in that the complex oxide is a titanate of formula LiᵢTiₘM′_{m′}OₒNₙF_{f}.

9. The material as claimed in claim 1, characterized in that the complex oxide corresponds to the formula LiᵢMₘM′_{m′}Z_{z}OₒNₙF_{f} in which z>0.

10. The material as claimed in claim 9, characterized in that the complex oxide is chosen from the oxides which correspond to the general formula LiMM′ZO₄ and which have an olivine structure or from the materials which correspond to the general formula Li₃₊ₓ(MM′)₂(ZO₄)₃ and which have the Nasicon structure, said complex oxides encompassing the complex oxides which have differences in stoichiometry of less than 5%, a degree of chemical impurities of less than 2% and a degree of elements of substitution of the crystalline sites M of less than 20%, and also the complex oxides in which the polyanions ZO₄ are partially replaced with molybdenate, niobate, tungstate, zirconate or tantalite polyanions to a degree of less than 5%.

11. The material as claimed in claim 10, characterized in that Z represents phosphorus, n>0 and/or f>0.

12. The material as claimed in claim 11, characterized in that the complex oxide is a phosphate, a pyrophosphate or an oxyphosphate.

13. The material as claimed in claim 12, characterized in that the complex oxide is LiFePO₄ or the complex oxide corresponds to the formula LiFe₁₋ₓMgₓPO₄ in which x ranges between 0.1 at. % and 5 at. %.

14. The material as claimed in claim 9, characterized in that the complex oxide corresponds to formula I in which Z represents Si or S.

15. The material as claimed in claim 14, characterized in that the complex oxide is a silicate, a sulfate or an oxysulfate in which M1 is Fe or Mg or a mixture thereof.

16. The material as claimed in claim 10, characterized in that M is Fe or Mn, o=4, and n=f=0.

17. The material as claimed in claim 1, characterized in that the functional group GF meets at least one of the following criteria:
it is hydrophilic in nature;
it constitutes a polymeric segment;
it has redox properties and/or electron conductivity;
it carries or constitutes a functional group FR capable of reacting by substitution, addition, condensation or polymerization, or a functional group capable of initiating anionic, cationic or radical polymerization reactions;
it carries ionic groups.

18. The material as claimed in claim 17, characterized in that the GF group is a group that is hydrophilic in nature, chosen from ionic groups and groups consisting of a hydrophilic polymer segment.

19. The material as claimed in claim 18, characterized in that GF is an ionic group chosen from the groups CO₂M, —OH, —SM, —SO₃M, —PO₃M₂, —PO₃M₂, —PO₂M and NH₂, and in which M represents a proton, an alkali metal cation or an organic cation.

20. The material as claimed in claim 19, characterized in that the organic cation is chosen from oxonium, ammonium, quaternary ammonium, amidinium, guanidinium, pyridinium, morpholinium, pyrrolidionium, imidazolium, imidazolinium, triazolium, sulfonium, phosphonium, iodonium and carbonium groups, said groups optionally with at least one substituent having an FR functional group capable of reacting by substitution, addition, condensation or polymerization.

21. The material as claimed in claim 18, characterized in that GF is a group derived from a hydrophilic polymer.

22. The material as claimed in claim 21, characterized in that the hydrophilic polymer is a polyalkylene comprising heteroatoms such as oxygen, sulfur or nitrogen.

23. The material as claimed in claim 22, characterized in that the hydrophilic polymer is a poly(oxyethylene), a poly(ethyleneimine), a polyvinyl alcohol, or an ionomer having, in its macromolecular chain, acrylate groups, styrene carboxylate groups, styrene sulfonate groups, allylamine groups or allyl alcohol groups.

24. The material as claimed in claim 17, characterized in that GF is a polymer group which comprises one or more segments chosen from a poly(oxyethylene), a segment with elastomer properties, and a segment which has conjugated double bonds capable of ensuring electron conduction.

25. The material as claimed in claim 17, characterized in that the FR group is chosen from isocyanate, epoxide, aziridine, thiaaziridine, amine, oxazoline, carboxyl, carboxylate, hydroxyl, chlorine and >C═C< groups.

26. The material as claimed in claim 1, characterized in that the carbon layer represents from 0.1% to 10% relative to the material.

27. The material as claimed in claim 1, characterized in that it carries from 0.0001 to 1 meq of GF functions per gram of material.

28. The material as claimed in claim 1, characterized in that the carbon layer is nonpowdery and adherent to the complex oxide.

29. The material as claimed in claim 1, characterized in that the carbon layer comprises carbon nanotubes.

30. Process for preparing a material as claimed in claim 1, characterized in that it comprises:
a) the preparation of complex oxide particles or particulate aggregates such that at least 90% of the particles are between 1 nm and 5 μm in size and at least 90% of the particulate aggregates are between 10 nm and 10 μm in size, said complex oxide corresponding to the formula LiᵢMₘM′_{m′}Z_{z}OₒNₙF_{f} in which:
Li, O, N and F represent, respectively, lithium, oxygen, nitrogen and fluorine;
M represents one or more elements chosen from transition metals;
M′ represents one or more metals other than a transition metal;
Z represents at least one element other than a metal;
the coefficients i, m, m′, z, o, n and f are chosen so as to ensure electroneutrality of the complex oxide, and meet the following conditions:
i≧0, m>0, z≧0, m′≧0, o>0, n≧0 and f≧0;
b) the deposition of carbon onto at least part of the surface of the complex oxide particles or particulate aggregates or onto at least part of the surface of the precursors of the complex oxide particles or particulate aggregates;
c) the bonding of GF functional groups by formation of a covalent bond with the carbon;
it being understood that the steps can be carried out successively or simultaneously.

31. The process as claimed in claim 30, characterized in that phases a), b) and c) are carried out in three successive steps, during which the complex oxide is first prepared, and then the carbonaceous coating is applied to the complex oxide particles or particulate aggregates and, finally, the carbonaceous particles or particulate aggregates are subjected to a treatment aimed at bonding GF functional groups.

32. The process as claimed in claim 31, characterized in that the carbonaceous coating is applied by carbonization of a precursor.

33. The process as claimed in claim 32, characterized in that the precursor is mixed, prior to the carbonization, with carbon particles or carbon fibers, including carbon nanotubes, optionally containing GF groups.

34. The process as claimed in claim 31, characterized in that the application of the carbonaceous coating is carried out by mechanofusion.

35. The process as claimed in claim 30, characterized in that the preparation of the complex oxide particles or particulate aggregates and the carbon deposition are carried out simultaneously in order to prepare a carbonaceous complex oxide, and the bonding of the GF groups is carried out on the carbonaceous complex oxide.

36. The process as claimed in claim 35, characterized in that the carbonaceous complex oxide is obtained by carrying out the synthesis of the complex oxide using the complex oxide precursors and one or more carbon precursors.

37. The process as claimed in claim 30, characterized in that there is simultaneous formation of a deposit of carbon and GF groups on complex oxide particles or particulate aggregates prepared beforehand.

38. The process as claimed in claim 37, characterized in that the GF groups are carboxylate, hydroxyl, ketone or aldehyde groups, and the grafting thereof is carried out by oxidation of the carbon with CO₂, optionally in the presence of water vapor.

39. The process as claimed in claim 30, characterized in that the GF groups are carboxylate, hydroxyl, ketone or aldehyde groups, and steps a), b) and c) of the process are carried out simultaneously.

40. The process as claimed in claim 30, characterized in that the carbon is applied by carbonization of a precursor brought into contact with the complex oxide particles beforehand.

41. The process as claimed in claim 40, characterized in that the precursor is in the form of a liquid precursor, a gas precursor or a solid precursor used in the molten state or in solution in a liquid solvent.

42. The process as claimed in claim 40, characterized in that the carbonization is dismutation of CO, dehydrogenation of a hydrocarbon, dehalogenation or dehydrohalogenation of a halogenated hydrocarbon, or cracking of a hydrocarbon.

43. The process as claimed in claim 40, characterized in that the precursor is mixed, prior to carbonization, with carbon particles or carbon fibers, including carbon nanotubes, optionally containing GF groups.

44. The process as claimed in claim 30, characterized in that the carbon layer is deposited by mechanofusion.

45. A composite electrode consisting of a composite material deposited onto a current collector, characterized in that the composite material comprises an electrode material as claimed in claim 1 and, optionally, a binder and/or an agent that confers electron conductivity and/or an agent that confers ionic conductivity.

46. The electrode as claimed in claim 45, characterized in that the electrode material carries GF groups that are hydrophilic in nature.

47. The electrode as claimed in claim 45, characterized in that the composite material comprises the electrode material and a binder.

48. The electrode as claimed in claim 47, characterized in that the binder is chosen from natural rubbers and synthetic rubbers such as SBR (styrene butadiene rubber), NBR (butadiene-acrylonitrile-rubber), HNBR (hydrogenated NBRs), CHR (epichlorohydrin rubber) and ACM (acrylate rubber) rubbers.

49. The electrode as claimed in claim 47, characterized in that the composite material deposited onto a current collector consists of carbonaceous complex oxide particles or particulate aggregates attached to binder nanoparticles.

50. The electrode as claimed in claim 49, characterized in that the binder nanoparticles have a diameter <50 nm.

51. The electrode as claimed in claim 45, characterized in that the composite material deposited onto a current collector comprises an electrode material which carries GF groups of the polymer type and, optionally, GF groups that are hydrophilic in nature.

52. The electrode as claimed in claim 49, characterized in that the GF groups of the polymer type consist of a poly(oxyethylene) segment, or a segment with conjugated double bonds.

53. The electrode as claimed in claim 45, characterized in that the composite material which is deposited onto a current collector consists of complex oxide particles coated with carbon and bonded to one another by covalent bonding or by ionic bonding.

54. The electrode as claimed in claim 45, characterized in that the complex oxide is LiFe₁₋ₓMgₓPO₄ in which x ranges between 0.1 at. % and 5 at. %, or LiFePO₄.

55. The electrode as claimed in claim 54, characterized in that the carbon layer carries GF groups chosen from —COOH, >C═O, —OH and —CHO.

56. The electrode as claimed in claim 45, characterized in that the oxide or particularly Li₄Ti₅O₁₂.

57. A process for producing an electrode as claimed in claim 48, characterized in that the binder is incorporated into the electrode material by mechanical mixing in the presence of a solvent.

58. A process for producing an electrode as claimed in claim 48, characterized in that:
the electrode material carries GF groups which are or which carry an FR functional group for facilitating the dispersion of the functionalized carbonaceous complex oxide particles or aggregates, and GFa groups which are or which carry an FRa functional group capable of reacting by addition or condensation;
the binder carries reactive groups GA capable of reacting by addition or condensation with the FRa groups of the material I;
the particles or particulate aggregates of material I are dispersed in a colloidal suspension of binder nanoparticles;
the dispersion is coated onto a substrate which constitutes the current collector of the electrode;
the dispersion is subjected to a treatment aimed at reacting the FR functions with the GA groups.

59. The process for producing an electrode as claimed in claim 51, characterized in that:
a composite material is prepared from an electrode material carrying GF groups which are or which carry an FR functional group capable of reacting by addition or condensation with an identical functional group;
the composite material is applied to a substrate which constitutes the current collector of the electrode;
the composite material is subjected to a treatment aimed at reacting the FR functions with one another.

60. A lithium generator, consisting of an electrolyte comprising a lithium salt between two electrodes, and operating by lithium ion exchange, characterized in that at least one of the electrodes is a composite electrode as claimed in claim 45.

61. The generator as claimed in claim 57, characterized in that the complex oxide of the electrode corresponds to the formula LiᵢMₘM′_{m′}OₒNₙF_{f}, said electrode operating as an anode.

62. The generator as claimed in claim 57, characterized in that the complex oxide of the electrode corresponds to the formula LiᵢMₘM′_{m′}Z_{z}OₒNₙF_{f} in which z>0, said electrode operating as a cathode.
